(19) United States
(12) Patent Application Publication
(10) Pub. No.: US 2026/0264775 A1
(43) Pub. Date: Sep. 10, 2026

(54) SYSTEMS, METHODS, AND MEDIA FOR PREDICTING A STATE OF A FIFTH WHEEL BASED ON VIBRATION THEREOF

(71) Applicant: Fontaine Fifth Wheel Company, Jasper, AL (US)

(72) Inventors: Jesse Payton, Falkville, AL (US); Will Brandon Drake, Cullman, AL (US)

(73) Assignee: Fontaine Fifth Wheel Company, Jasper, AL (US)

(21) Appl. No.: 19/553,754

(22) Filed: Mar. 2, 2026

Related U.S. Application Data
(60) Provisional application No. 63/767,124, filed on Mar. 5, 2025.

(51) Int. Cl. B62D 53/08; G01H 11/08; G07C 5/00; G07C 5/08; H04R 17/02

(52) U.S. Cl. CPC B62D 53/0885; G01H 11/08; G07C 5/008; G07C 5/0816; H04R 17/02; B62D 53/0842; H04R 2499/13

(57) ABSTRACT

In accordance with some embodiments, systems, methods, and media for monitoring a state of a fifth wheel are provided. In some embodiments, the system comprises: a vibration sensor configured to be mounted to a portion of the fifth wheel; and one or more hardware processors configured to: provide a frequency domain representation of a sample of vibration data recorded using the vibration sensor to a trained machine learning model that is trained to predict a state of a fifth wheel based on vibrations of the fifth wheel; receive, from the trained machine learning model, an output indicative of a predicted state of the fifth wheel at the time that the sample of vibration data was recorded; and transmit a signal to an external device that is indicative of a current predicted state of the fifth wheel.

### CROSS-REFERENCE TO RELATED APPLICATIONS

This application claims priority to U.S. Provisional Patent Application No. 63/767,124, filed Mar. 5, 2025, the contents of which is hereby incorporated by reference in its entirety.

### BACKGROUND

A fifth wheel is a device that can be used to connect a tractor and a trailer of a class 8 vehicle. A top plate of the fifth wheel acts as a bearing surface as the trailer rotates relative to the tractor during turning. Various operating states and maintenance conditions of fifth wheel devices are of interest to vehicle operators and vehicle maintenance personnel. For example, operating states of interest include whether the trailer is correctly coupled with the tractor, and maintenance conditions of interest include whether the fifth wheel is properly lubricated, and the wear condition of the fifth wheel.

### SUMMARY

In accordance with some embodiments of the disclosed subject matter, a system for monitoring a state of a fifth wheel is provided, the system comprising: a vibration sensor configured to be mounted to a portion of the fifth wheel; and one or more hardware processors configured to: provide a frequency domain representation of a sample of vibration data recorded using the vibration sensor to a trained machine learning model that is trained to predict a state of a fifth wheel based on vibrations of the fifth wheel; receive, from the trained machine learning model, an output indicative of a predicted state of the fifth wheel at a time that the sample of vibration data was recorded; and transmit a signal to an external device that is indicative of a current predicted state of the fifth wheel.

In some embodiments the one or more hardware processors are further configured to: receive, from a vibration data source, the sample of vibration data; normalize the sample of vibration data; and convert the sample of vibration data to the frequency domain representation.

In some embodiments the vibration data source comprises the vibration sensor.

In some embodiments the frequency domain representation comprises a spectrogram.

In some embodiments the vibration sensor comprises a piezoelectric microphone.

In some embodiments the trained machine learning model is a classification model that is trained to predict a likelihood that the fifth wheel from which the vibration data was recorded is an example of each of a plurality of classes.

In some embodiments the trained machine learning model is trained to predict whether the fifth wheel is properly lubricated.

In some embodiments the plurality of classes includes a properly lubricated class.

In some embodiments the one or more hardware processors are further configured to: receive, from the trained machine learning model, a plurality of outputs indicative of a predicted state of the fifth wheel at different times; and determine a final prediction based on the plurality of outputs; determine that a user is to be presented with an alert based on the final prediction; and transmit the signal to the external device, thereby causing an alert to be presented to the user by the external device.

In some embodiments the external device is a mobile computing device associated with the user.

In some embodiments the external device is an embedded computing device of a tractor to which the fifth wheel is mounted.

In some embodiments the external device is a dashboard of a tractor to which the fifth wheel is mounted.

In some embodiments the external device is a remote computing device associated with a cloud computing service. In some embodiments the one or more hardware processors are further configured to: receive, from the vibration sensor, a stream of audio data; record a portion of the stream of audio data as an audio file; divide the audio file into a plurality of vibration data samples, including the sample of vibration data; normalize each of the plurality of the vibration data samples based on audio levels within the respective sample; convert the plurality of vibration data samples into a plurality of mel spectrograms; provide the plurality of mel spectrograms to the trained machine learning model as a batch; receive a plurality of outputs, each corresponding to a respective vibration data sample of the plurality of vibration data samples, and each indicative of the predicted state of the fifth wheel at a time that the respective vibration data sample was recorded; and determine a final prediction based on the plurality of outputs.

In some embodiments the audio file corresponds to about 16 seconds of audio data recorded at a sample rate of 96 kHz, and wherein each of the vibration data samples corresponds to about two seconds of the audio file and is downsampled to a sample rate of 10 KHz.

In some embodiments the trained machine learning model is a regression model that is trained to predict a current state of the fifth wheel from which the vibration data was recorded from a range of states.

In some embodiments the state that the trained machine learning model is trained to predict is whether the fifth wheel is in a particular operating state.

In some embodiments the particular operating state is one of the following: a properly locked state; a fully unlocked state; a jammed state; or a properly coupled state.

In some embodiments the state that the trained machine learning model is trained to predict is a maintenance condition of the fifth wheel.

In some embodiments the maintenance condition is one of the following: whether a top plate of the fifth wheel is sufficiently lubricated; whether a locking mechanism plate of the fifth wheel is sufficiently lubricated; a condition of the lubrication on the fifth wheel; a wear condition of the top plate of the fifth wheel; a wear condition of a friction-reducing plate coupled to the fifth wheel; or a wear condition of the locking mechanism of the fifth wheel.

In some embodiments the state that the trained machine learning model is trained to predict is whether a particular event occurred during a time period represented by the frequency domain representation.

In some embodiments the particular event is successful coupling of the fifth wheel to a kingpin of a trailer.

In some embodiments, the one or more hardware processors are further configured to: provide a second frequency domain representation of the sample of vibration data to a second trained machine learning model that is trained to predict a different state of the fifth wheel based on vibrations of the fifth wheel.

In some embodiments, the system further comprises: the fifth wheel, wherein the vibration sensor is mounted to an underside of the fifth wheel; and an automated greasing device configured to dispense grease to a top plate of the fifth wheel; and wherein the one or more hardware processors configured to: determine, based on the output received from the trained machine learning model, that the fifth wheel is not properly greased; and transmit the signal to the automated greasing device, wherein the signal comprises an instruction to the automated greasing device that causes the automated greasing device to dispense a predetermined amount of grease to the fifth wheel.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1A shows an example of a top view of a fifth wheel and a system for predicting a state of the fifth wheel based on vibration thereof in accordance with some embodiments of the disclosed subject matter.

FIG. 1B shows an example of an underside view of the fifth wheel and the system shown in FIG. 1A in accordance with some embodiments of the disclosed subject matter.

FIG. 1C shows an example of a vibration-sensor-equipped fifth wheel connected to a trailer in accordance with some embodiments of the disclosed subject matter.

FIG. 2 shows an example of a system for predicting a state of a fifth wheel based on vibration thereof in accordance with some embodiments of the disclosed subject matter.

FIG. 3 shows an example of hardware that can be used to implement a vibration data source, a local computing device, and a remote computing device in accordance with some embodiments of the disclosure.

FIG. 4 shows an example of a flow for training and using mechanisms for predicting a state of a fifth wheel based on vibration thereof in accordance with some embodiments of the disclosed subject matter.

FIG. 5 shows an example of a process for predicting a state of a fifth wheel based on vibration thereof in accordance with some embodiments of the disclosed subject matter.

FIG. 6 shows an example of a process for pre-processing vibration data in accordance with some embodiments of the disclosed subject matter.

FIG. 7A shows an example of a high level architecture of a machine learning model that can be used to implement mechanisms for predicting a state of a fifth wheel based on vibration thereof in accordance with some embodiments of the disclosed subject matter.

FIG. 7B shows an example of a spectrogram that can be used to train a machine learning model in accordance with some embodiments of the disclosed subject matter.

### DETAILED DESCRIPTION

One common type of connection assembly used to couple a towed trailer to a towing vehicle (e.g., a tractor of a class 8 vehicle) is often referred to as a fifth wheel. A fifth wheel can include a locking assembly on the towing vehicle that engages a kingpin of a towed trailer to thereby couple the towing vehicle to the towed trailer and can be constructed to mitigate occurrences of inadvertent disengagement of the kingpin from the fifth wheel.

In general, a fifth wheel is configured to receive the kingpin via a throat when in an unlocked position, and to transition (e.g., automatically) to a locked position when the kingpin is properly inserted. Additionally, fifth wheels are generally configured with a top plate that acts as a bearing surface for a load bearing portion of the trailer, allowing the trailer to rotate relative to the tractor during turning. When the interface(s) between the fifth wheel and trailer are properly lubricated, rotation of the tractor and trailer is relatively smooth, and the fifth wheel can be expected to operate efficiently and experience normal wear for a relatively long time with regular maintenance. However, when the interface(s) between the fifth wheel and trailer are not properly lubricated (e.g., when there is insufficient grease, when the condition of the grease has degraded, when the condition of a grease-less friction reduction solution such as a slick plate has degraded, etc.), the lack of proper lubrication can cause an increase in friction between the top plate of the fifth wheel and the trailer when the tractor is turning. This can lead to various undesirable outcomes. For example, increased friction at an interface between the top plate and bearing surface of the trailer can cause excessive wear to the top plate and trailer bearing surfaces (e.g., decreasing the lifetime of the fifth wheel and/or trailer, increasing maintenance costs, etc.). As another example, increased friction at an interface between a jaw(s) of the fifth wheel and the kingpin of the trailer can cause excessive wear to the coupling components of the fifth wheel and trailer. As yet another example, increased friction between the fifth wheel and trailer can negatively impact the efficiency of the tractor, and increased turning force can lead to increased wear on the steer tires (e.g., leading to more frequent replacement of tires, which are generally one of the largest maintenance expenses for heavy duty transportation vehicles).

In general, whether a fifth wheel is properly lubricated may not be readily apparent when operating the vehicle, and may only become apparent if the fifth wheel is visually inspected (e.g., when a trailer is disconnected), or when excessive wear of the fifth wheel, trailer, tires, etc., causes an increase in maintenance costs and/or leads to a failure in operation of the fifth wheel and/or vehicle (e.g., a tire blow out, failure of a fifth wheel locking mechanism, improper coupling, etc.). Additionally, when a trailer is coupled to the fifth wheel, it can be difficult to visually determine whether the interfaces between the trailer and fifth wheel are properly lubricated. Even if the fifth wheel and/or trailer are properly lubricated prior to coupling, the process of coupling the fifth wheel and trailer can cause lubrication to be displaced, which may not be readily apparent in a visual inspection.

In some embodiments, mechanisms described herein can use one or more vibration sensors configured to detect vibrations of the fifth wheel (e.g., during coupling or uncoupling, during locking or unlocking, during driving, etc.), and characteristics of the vibration can be used to automatically predict a state of the fifth wheel (e.g., whether the fifth wheel is properly or improperly greased). In some embodiments, mechanisms described herein can be used to detect other conditions and/or events associated with the fifth wheel using vibration data collected from the fifth wheel, such as whether the tractor and trailer are properly connected, a wear condition of the fifth wheel, adjustments of the fifth wheel (e.g., adjustment of an element, such as an adjustment screw or bolt, that can be used to adjust a position and/or travel of another component of the fifth wheel, such as a locking wedge), an approximate vertical load on the fifth wheel (e.g., accurate to within hundreds to thousands of pounds), and/or any other suitable operating state and/or maintenance condition that can be differentiated based on characteristics of the vibration of the fifth wheel. For example, although mechanisms described herein are described most often in connection with predicting a lubrication state of the fifth wheel, mechanisms described herein can be implemented to predict whether a tractor and trailer have been properly connected and/or disconnected (e.g., using vibration data corresponding to the time period when the tractor and trailer are coupled together or uncoupled). As another example, mechanisms described herein can be implemented to predict whether a tractor and trailer are properly connected (e.g., using vibration data corresponding to a time period(s) when the tractor and trailer are being driven). As yet another example, mechanisms described herein can be implemented to predict a wear condition of the fifth wheel (e.g., using vibration data corresponding to a time period(s) when the fifth wheel is being operated to lock or unlock, is being coupled to a trailer, is being used to tow a trailer, etc.).

In some embodiments, mechanisms described herein can be implemented using hardware and software, such as via a system for predicting a state of the fifth wheel based on vibration that includes: a vibration-sensitive transducer (e.g., a piezoelectric microphone) attached to an underside of a fifth wheel top plate; a local electronic device that receives vibration data from the vibration-sensitive transducer and predicts a state of the fifth wheel using the vibration data; and an output module that provides access to the prediction(s) generated by the local computing device and/or alerts a user to the predicted state of the fifth wheel.

In some embodiments, such a local electronic device can include: memory that stores software code (e.g., instructions and values), vibration data, and a trained machine learning model (e.g., parameters with values determined via a training process); a processor (e.g., a microcontroller) that processes received vibration data, executes the trained machine learning model, and generates predictions using the trained machine learning model and processed vibration data; and an input/output interface that receives signals from the vibration-sensitive transducer (and/or any other suitable source) and outputs predictions (e.g., to be presented to a user). In some embodiments, such an output module can convey a final prediction(s) to a user, a vehicle telematics system, one or more other vehicle systems, and/or an automated maintenance device (e.g., an automated fifth wheel greasing system).

In some embodiments, a system for predicting a state of a fifth wheel based on vibration thereof can use a refinement process (e.g., executed by the local computing device and/or another computing device which may be local or remote) that analyzes a prediction(s) output by a trained machine learning model to enhance the accuracy and reliability of final predictions generated using the system. For example, the refinement process can use the prediction(s) and temporal and occurrence criteria to determine the final prediction. As another example, the refinement process can incorporate other types of data (e.g., other than vibration data) from another source(s) (e.g., vehicle speed, vehicle loading condition, make/model of fifth wheel, tractor and/or trailer information, etc.) when determining a final prediction.

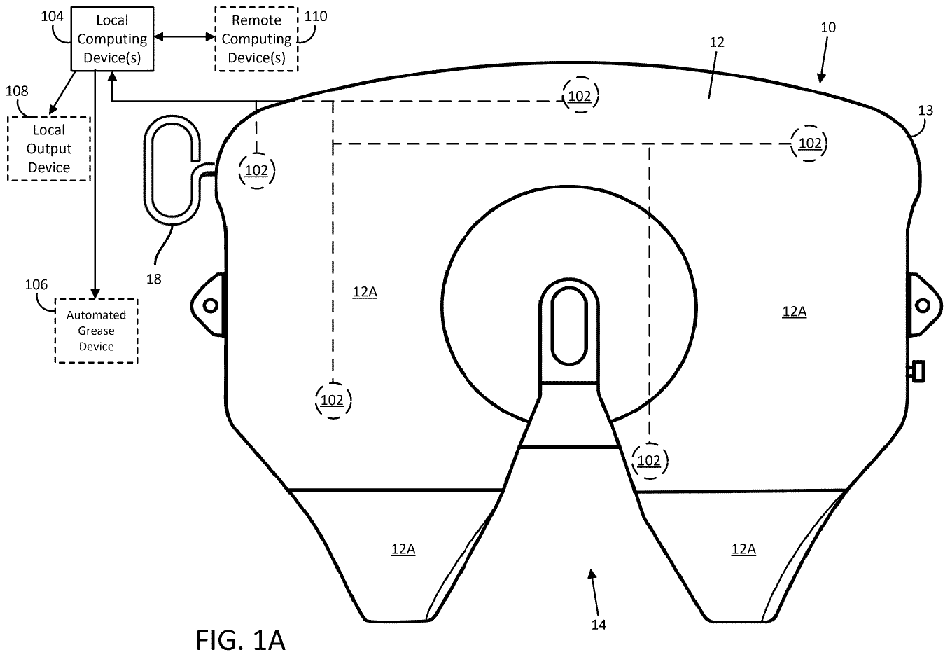

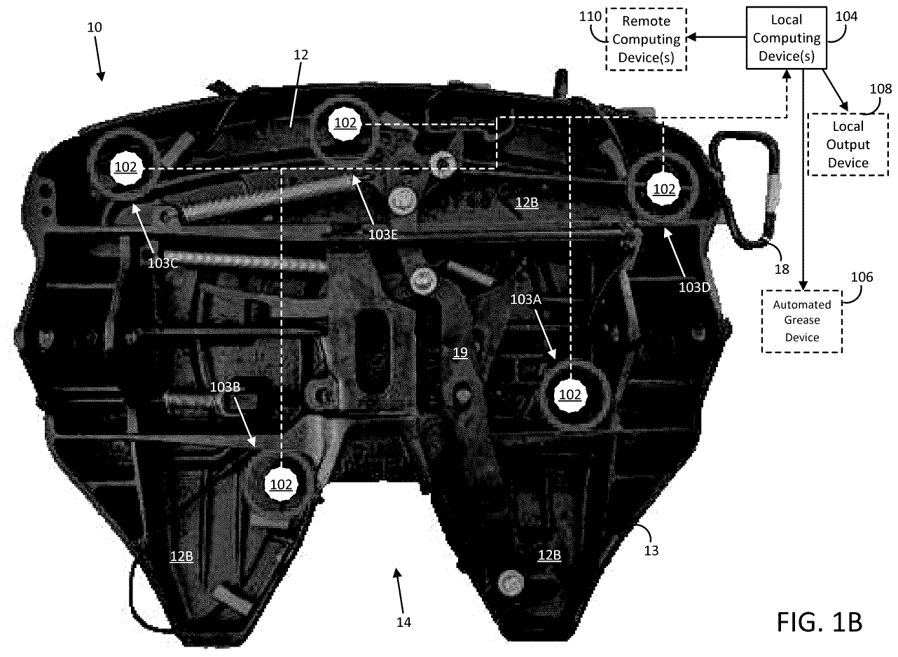

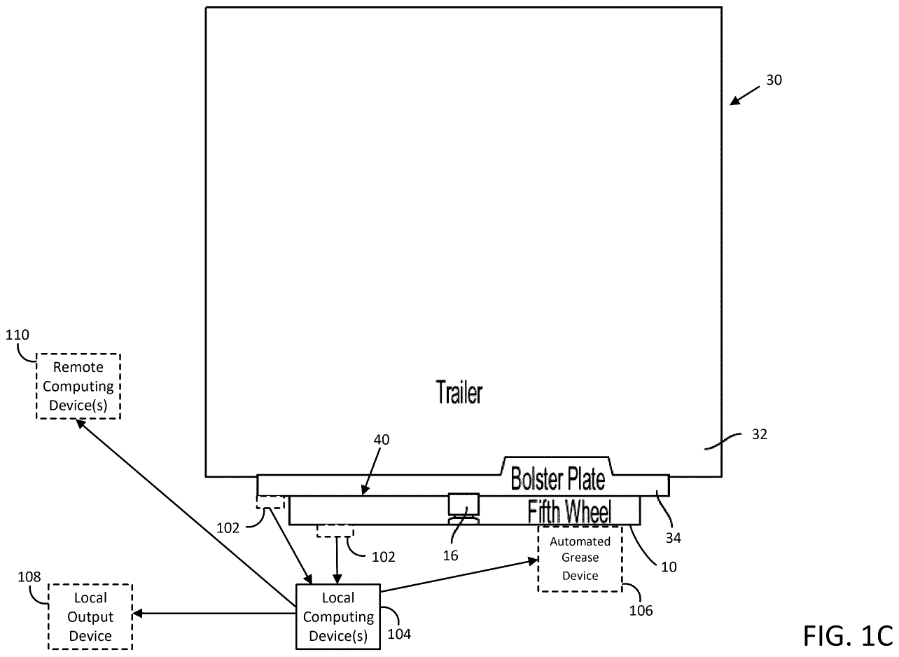

FIGS. 1A and 1B show example views of a fifth wheel 10 and a system for predicting a state of the fifth wheel based on vibration thereof in accordance with some embodiments of the disclosed subject matter. As shown in FIGS. 1A and 1B, fifth wheel 10 can include a top plate 12 having a top surface 12A and a bottom surface 12B, a perimetral flange 13, a receiving throat 14 in which a kingpin of a towed trailer is received (e.g., kingpin 16 shown in FIG. 1C), and a handle 18. In some embodiments, top plate 12 can include a variety of stabilizing and/or strengthening structures, such as gussets, flanges, ribs, etc., that strengthen and support top plate 12 and perimetral flange 13 and/or provide point(s) of attachment for various components of fifth wheel 10. In some embodiments, top plate 12 and perimetral flange 13 can define a protected space in which operable components of fifth wheel 10 and/or other associated systems can be located.

As shown in FIG. 1B, an operating arm 19 can be pivotally connected to top plate 12 via a pivot axis and can be pivotable into and between a locked position in which fifth wheel 10 couples to the kingpin and an unlocked position in which fifth wheel 10 decouples from the kingpin. A pivoting end of operating arm 19 can be pivotally coupled to top plate 12 at the pivot axis proximate to an opening of throat 14 via a mechanical fastener such as a pin or bolt. One or more mechanical components (e.g., one or more coil springs) can be used to bias (e.g. pull) operating arm 19 toward the throat 14 in a first direction (e.g., such that the middle of operating arm 19 is proximate to throat 14 and an opposite, translational end of operating arm 19 is relatively centered between a handle side of fifth wheel 10 and the opposite side), which can facilitate locking from the unlocking position when the fifth wheel is in the locked position. Handle 18 can be coupled to operating arm 19 and can be operated to pivot operating arm 19 from the locked position to the unlocked position, facilitating release of a kingpin coupled to fifth wheel 10 and/or coupling of a kingpin to fifth wheel 10. For example, pulling handle 18 away from perimetral flange 13 can cause operating arm 19 to pivot toward the unlocked position, and away from throat 14 (e.g., such that the middle of operating arm 19 farther from throat 14 and the opposite end of operating arm 19 is closer to the handle side of fifth wheel 10 than to the center).

In the example shown in FIGS. 1A and 1B, as operating arm 19 pivots toward the unlocked position, a locking component(s) (e.g., a wedge and a jaw), which can be pivotally coupled to operating arm 19, can also move away from throat 14. One or more additional mechanical components, such as a trigger arm (not labeled), can hold operating arm 19. This can allow a kingpin to be inserted into, and/or removed from, throat 14. Insertion of a kingpin into throat 14 can cause operating arm 19 to pivot back to the locked position (e.g., the kingpin can release the trigger arm, and the biasing component can exert a pulling force on operating arm 19). As operating arm 19 pivots toward the locked position, the locking component(s) can be also moved toward and/or through throat 14 and can securely couple the kingpin to fifth wheel 10 (e.g., between a locking jaw that moves with operating arm 19 and a fixed jaw that remains static during movement of operating arm 19). A secondary lock assembly (not labeled) can hold operating arm 19 in the locked position (e.g., via a pawl) and can be coupled between the translational end of operating arm 19 (e.g., via a mechanical fastener) and handle 18, such that pulling handle 18 away from perimetral flange 13 unlocks fifth wheel 10 from the locked position. One or more mechanical components (e.g., one or more coil springs) can be used to bias the secondary lock assembly toward the center of fifth wheel 10 to urge the secondary lock assembly, and the translational end of operating arm 19 coupled to the secondary lock assembly, toward the locked position (e.g., in response to a kingpin engaging with the trigger arm). Note that FIGS. 1A and 1B show a specific example of components that can be used to implement a fifth wheel and associated locking mechanism, and fifth wheels and associated locking mechanisms can be implemented with many different types and configurations of components. Mechanisms described herein can be used in connection with other types and/or configurations of components, and can be expected to provide similar results.

In some embodiments, one or more vibration sensors 102 can be mounted to fifth wheel 10 such that a vibration sensing component(s) is capable of detecting vibrations of fifth wheel 10. For example, as shown in FIG. 1B, a vibration sensor 102 can be mounted to bottom surface 12B of top plate 12 at various locations, such as mounting locations 103A to 103E shown in FIG. 1B. Additionally or alternatively, in some embodiments, each vibration sensor 102 can be mounted in any location (e.g., to a flange such as an interior or exterior of perimetral flange 13, gusset, rib, lip, within a cavity provided in top plate such as a cavity with that is open to top surface 12A, bottom surface 12B, perimetral flange 13, etc.) that does not interfere with operation of fifth wheel 10 (e.g., locking, unlocking, pivoting of a coupled kingpin and trailer, etc.), and that is capable of detecting vibrations of fifth wheel 10. In some embodiments, vibration sensor 102 can be mounted to fifth wheel 10 using any suitable technique or combination of techniques. For example, vibration sensor 102 can be mounted using an adhesive (e.g., glue, epoxy, etc.), an adhesive tape (e.g., double sided tape), a mechanical fastener(s) that mechanically couples a portion of vibration sensor 102 directly to a portion of fifth wheel 10, a bracket that secures vibration sensor 102 in place in relation to fifth wheel 10, etc.

In some embodiments, mounting vibration sensor 102 to fifth wheel 10 and providing a wired connection to local computing device 104 coupled to the tractor can provide relatively easy access to a communication network (e.g., via an existing connection used by computing device 104 for another purpose, such as telematics, fifth wheel locking mechanism operation monitoring, etc.). Additionally, in some embodiments, mounting vibration sensor 102 to fifth wheel 10 and providing a wired connection to local computing device 104 coupled to the tractor can facilitate one-to-one monitoring of a particular fifth wheel using a particular vibration sensor(s) 102, which may be more efficient for certain fleet operators and/or independent operators, and/or less complex to monitor. For example, most fleet operators operate more trailers than tractors, allowing the operator to provide fewer fifth wheel monitoring systems including vibration sensor 102 to monitor all fifth wheels in the operator's fleet. As another example, when a fifth wheel monitoring system including vibration sensor 102 is mounted to a tractor, the fifth wheel being monitored is consistent (e.g., data from vibration sensor 102 and/or local computing device 104 can be associated with a particular tractor and/or fifth wheel based on the identify of the vibration sensor and/or local computing device), mitigating a need to associate vibration sensor 102 with a particular fifth wheel and/or tractor if vibration sensor 102 is mounted to a trailer that can be coupled to many different tractors. Additionally, in some embodiments, mounting vibration sensor 102 to fifth wheel 10 providing power from the tractor can facilitate monitoring of the fifth wheel during coupling with a trailer and/or uncoupling from a trailer (e.g., as power may not be available to a fifth wheel monitoring system mounted to a trailer that is not receiving power from an external source, such as a tractor).

Mounting vibration sensor 102 to an underside of a fifth wheel can protect vibration sensor 102 from inadvertent damage (e.g., during operation of the vehicle, during coupling or uncoupling from a trailer, from road debris, from the elements, etc.). In some embodiments, different sensor locations can be more suitable for detecting certain conditions, and/or may be less suitable for detecting other conditions. For example, positions near a portion of the fifth wheel 10 that generate strong local vibrations (e.g., portions of the locking mechanism) can receive high amplitude vibrations that may impact the utility of such vibration data for detecting certain states of the fifth wheel. As a more particular example, a vibration sensor at position 103B can be expected to receive strong local vibrations during locking (e.g., when a locking jaw makes forceable contact with a kingpin during locking) which may saturate the sensor. A vibration signal that includes such a saturated signal may be useful for detecting that coupling has occurred but may not be useful for other purposes. As another more particular example, a vibration sensor at position 103D can be expected to receive strong local vibrations during driving if handle 18 rattles against a body of fifth wheel 10, and to receive strong local vibrations during locking if handle 18 makes contact with a body of fifth wheel 10 when operating arm 19 moves toward the locked position and causes handle 18 to retract into the body of fifth wheel 10. A vibration signal that includes a strong signal correlated with movement of handle 18 may be useful for detecting whether locking has properly occurred, whether the fifth wheel and a trailer are properly coupled, and/or whether fifth wheel 10 is properly lubricated (e.g., if characteristics of vibrations caused by movement of handle 18 that are detected by such a vibration sensor change significantly with differences in such states).

In some embodiments, vibration sensor 102 can be implemented using any suitable vibration sensing component(s) that can produce an electrical signal with a magnitude and/or frequency that modulates with the magnitude and/or frequency at which fifth wheel 10 vibrates. For example, vibration sensor 102 can include a vibration-sensitive transducer that generates a modulated electrical signal (e.g., an analog electrical signal) with a magnitude and/or frequency that is based on vibration of a surface of vibration sensor 102. In a more particular example, vibration sensor 102 can be implemented using a piezoelectric sensor configured to output a signal that is based on vibration that is mechanically received at a surface of vibration sensor 102. In such an example, the piezoelectric sensor can be mechanically coupled to a vibration receiving element (e.g., a diaphragm or external contact surface) of vibration sensor 102 such that vibrations received at the vibration receiving element are mechanically transmitted to the piezoelectric sensor, causing the piezoelectric sensor to output a modulated signal that has a magnitude and/or frequency that correspond to vibrations in a medium to which vibration sensor 102 is coupled. In a yet more particular example, vibration sensor 102 can be implemented using a piezoelectric contact microphone (e.g., similar to piezoelectric contact microphones sometimes used to electrify acoustic instruments, such as violins and guitars, such as a Schertler Dyn-Uni-P48 Contact Microphone made available by Schertler SA, headquartered in Mendrisio, Switzerland) with a contact surface of the microphone abutting a surface of fifth wheel 10. Note that although vibration sensor 102 is generally described herein as being a piezoelectric microphone, any suitable vibration sensor can be used that is configured to output a modulated electrical signal with properties that reflect vibrations in a surface. For example, vibration sensor 102 can be implemented using a condenser transducer microphone (e.g., similar to condenser microphones sometimes used to electrify acoustic instruments, such as violins and guitars, such as an AKG C411 L mini condenser microphone made available by Harmon International Industries, headquartered in Stamford, Connecticut). In some embodiments, vibration sensor 102 can be a passive sensor and/or can include one or more signal conditioning components (e.g., amplifiers, filters, analog to digital converters, digital signal processors, etc.) configured to improve the quality of the signal produced and/or output by vibration sensor 102, such that a signal received from vibration sensor 102 is a relatively high quality electrical signal (e.g., with a relatively high signal-to-noise ratio) that reflects vibration of one or more components of fifth wheel 10 with sufficient accuracy to predict a state of fifth wheel 10 based on vibration of at least a portion of fifth wheel 10 that is sensed by vibration sensor 102.

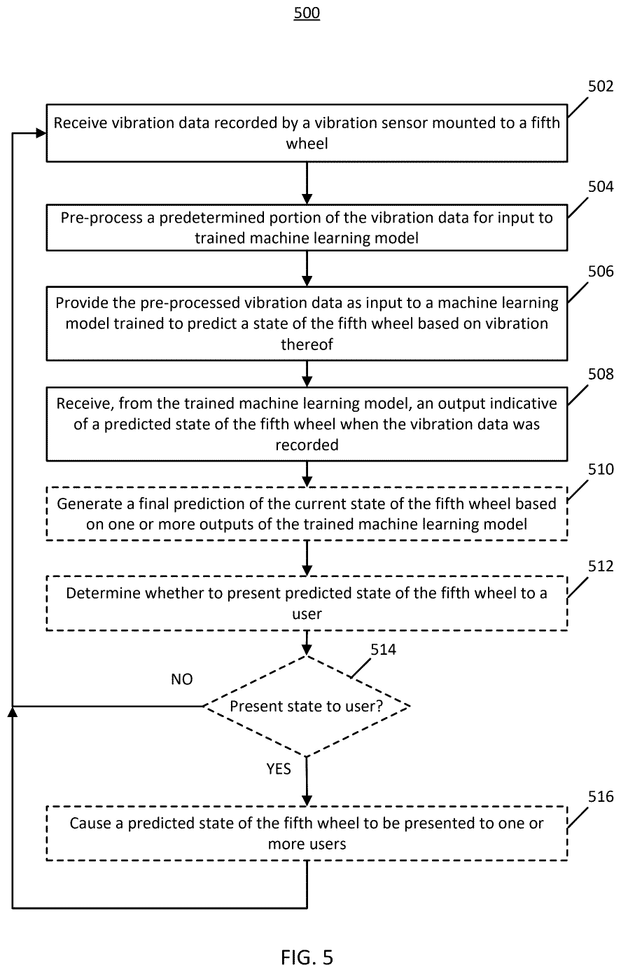

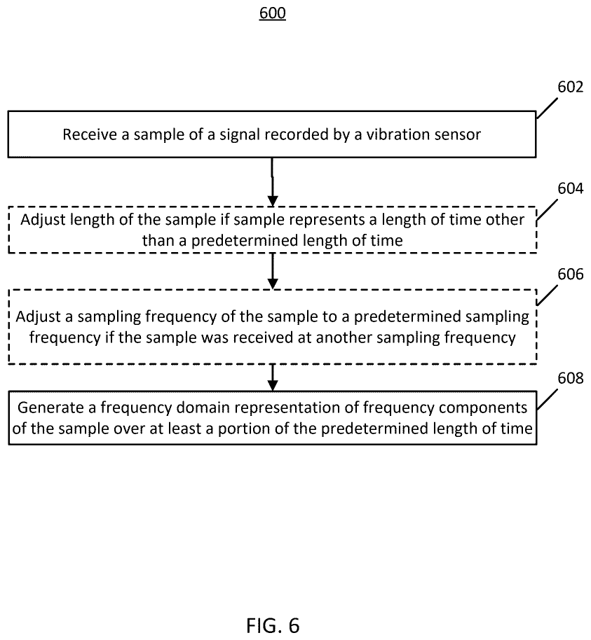

In some embodiments, vibration sensor 102 can be coupled to a local computing device 104 that is configured to receive signals produced by, and/or output by, a vibration sensor(s), and process the received signal(s) into a format that is suitable for use in predicting a state of the fifth wheel based on vibration of the fifth wheel that is encoded in the received signal (e.g., a spectrogram). For example, local computing device 104 can convert the received vibration signals into a format that is suitable for input to a machine learning model trained to predict a state of a fifth wheel based on vibration signals recorded from the fifth wheel. In some embodiments, local computing device 104 can receive raw or processed analog signals from one or more vibration sensors 102. Additionally or alternatively, in some embodiments, local computing device 104 can receive raw or processed digital signals from one or more vibration sensors 102. In some embodiments, local computing device 104 can execute at least a portion of a process for predicting a state of the fifth wheel based on the signal(s) received from one or more vibration sensors 102, either alone, or using additional data from one or more other data sources. For example, local computing device 104 can execute at least a portion of process 500 described below in connection with FIG. 5 and/or at least a portion of process 600 described below in connection with FIG. 6. As another example, local computing device 104 can execute an instance of a machine learning model trained to predict a state of the fifth wheel based on vibration thereof.

In some embodiments, local computing device 104 can be any suitable type of computing device. For example, local computing device 104 can be a special purpose computing device configured to receive data from a vibration sensor(s) mounted on a fifth wheel and predict a state of the fifth wheel based on vibration data received from the vibration sensors. In such an example, local computing device 104 may or may not be configured for direct user interaction. As another example, local computing device 104 can be a multi-purpose computing device configured to receive data from a vibration sensor(s) mounted on a fifth wheel and predict a state of the fifth wheel based on vibration data received from the vibration sensors, and perform other functions (e.g., local computing device 104 can be at least a portion of an after-market telematics system configured to monitor operation of the vehicle to which the fifth wheel is mounted). In such an example, local computing device 104 may or may not be configured for direct user interaction. As yet another example, local computing device 104 can be an embedded multi-purpose computing device configured to receive data from a vibration sensor(s) mounted on a fifth wheel and predict a state of the fifth wheel based on vibration data received from the vibration sensors, and perform other functions (e.g., local computing device 104 can be at least a portion of an electronic control unit of the vehicle to which the fifth wheel is mounted). In such an example, local computing device 104 may or may not be configured for direct user interaction. As still another example, local computing device 104 can be a general purpose computing device configured to receive data from a vibration sensor(s) mounted on a fifth wheel and predict a state of the fifth wheel based on vibration data received from the vibration sensors, and perform other functions (e.g., local computing device 104 can be a user device, such as a smartphone, tablet computer, laptop computer, etc.).

In some embodiments, local computing device 104 can control an automated fifth wheel greasing device 106 based on a predicted state of the fifth wheel. In some embodiments, automated fifth wheel greasing device 106 can be a device configured to dispense grease to one or more portions of fifth wheel 10. In some embodiments, local computing device 104 can communicate any suitable signals (e.g., data and/or instructions) to automated fifth wheel greasing device 106 using any suitable communications link or combination of communications links, such as wired links and/or wireless links. In some embodiments, local computing device 104 can cause automated fifth wheel greasing device 106 to dispense grease in response to predicting, based on vibration of fifth wheel 10, that fifth wheel 10 is in an insufficiently greased state.

In some embodiments, local computing device 104 can use a local output device 108 to present information about the predicted state of fifth wheel 10. In some embodiments, local output device 108 can be any suitable type of output device. For example, local output device 108 can be a special-purpose output device configured to inform a user about the predicted state of fifth wheel 10. In a more particular example, local output device 108 can be a visual indicator (e.g., an indicator light, indicator gauge, etc.) that is located where a user (e.g., a driver in a cab of the vehicle to which the fifth wheel is mounted) is likely to notice (e.g., see) a visual indicator of the predicted state of the fifth wheel, such that local output device 108 can be used to alert the user to the predicted state of the fifth wheel. As another more particular example, local output device 108 can be a non-visual indicator (e.g., a haptic feedback device, an audio device, etc.) that is located where a user is likely to notice (e.g., feel, hear) a non-visual indicator of the predicted state of the fifth wheel, such that local output device 108 can be used to alert the user to the predicted state of the fifth wheel. As another example, local output device 108 can be a multi-purpose output device configured to inform a user about the predicted state of fifth wheel 10 and perform other functions. As a more particular example, local output device 108 can be part of an in-vehicle information system (e.g., part of a dashboard, an infotainment system, etc.). As yet another example, local output device 108 can be a general-purpose user interface device (e.g., a smartphone, a wearable computing device, tablet computer, laptop computer, etc.), which can be configured to inform a user about the predicted state of fifth wheel 10, and perform other functions. As a more particular example, local output device 108 can be a user device that is connected to local computing device 104 (e.g., via a local wired or wireless communications link), and that can be configured to present information about the predicted state of fifth wheel 10 in response to receiving a signal (e.g., including data and/or instructions), such as notification (e.g., a visual pop-up notification, an audio notification, etc.).

In some embodiments, local computing device 104 can provide data and/or results to a remote computing device 110. In some embodiments, remote computing device 110 can be any suitable type of computing device that is physical and/or logically remote. For example, remote computing device 110 can be a server computer (e.g., a server of a cloud computing service, which may be a physical server and/or a virtual machine), a smartphone, a tablet computer, a wearable computer, etc., configured to receive data and/or results from a local computing device (e.g., local computing device 104) related to a fifth wheel (e.g., fifth wheel 10) and/or a predicted state of the fifth wheel. In a more particular example, remote computing device 110 can be a computing device(s) executing a backend of a fifth wheel condition monitoring system having a frontend that is being executed, at least in part, at local computing device 104. In a more particular example, local computing device 104 can collect data (e.g., from vibration sensor(s) 102) and/or generate results (e.g., a predicted state of the fifth wheel) based on received data. As another more particular example, remote computing device 110 can be a computing device(s) executing a backend of a vehicle monitoring system (e.g., a telematics system) having a frontend that is being executed, at least in part, at local computing device 104 and/or another local computing device.

In some embodiments, remote computing device 110 can be configured to receive data based on signals produced by, and/or output by, a vibration sensor(s) (e.g., vibration sensor 102), and process the received signal(s) into a format that is suitable for use in predicting a state of the fifth wheel based on vibration of the fifth wheel that is encoded in the received signal (e.g., a spectrogram). For example, remote computing device 110 can receive data (e.g., digital and/or analog values in which information from the vibration of the fifth wheel are encoded) from local computing device 104, and can convert the received vibration data into a format that is suitable for input to a machine learning model trained to predict a state of a fifth wheel based on vibration signals recorded from the fifth wheel. In some embodiments, remote computing device 110 can execute at least a portion of a process for predicting a state of the fifth wheel based on the signal(s) received from one or more vibration sensors 102 (e.g., received via local computing device 104), either alone, or using additional data from one or more other data sources. For example, remote computing device 110 can execute at least a portion of process 500 described below in connection with FIG. 5 and/or at least a portion of process 600 described below in connection with FIG. 6. As another example, remote computing device 110 can execute an instance of a machine learning model trained to predict a state of the fifth wheel based on vibration thereof. Additionally or alternatively, in some embodiments, remote computing device 110 can be configured to receive a result(s) (e.g., a predicted state of a fifth wheel), and cause information based on the result to be presented to a user (e.g., a driver of the vehicle associated with the fifth wheel, an owner of the tractor and/or trailer associated with the fifth wheel, a user associated with a fleet operator that manages a fleet that includes the tractor and/or trailer associated with the fifth wheel). For example, remote computing device 110 can be configured to provide access to a predicted state of the fifth (e.g., to a fleet operator, a driver, and/or any other suitable authorized user of a fifth wheel condition monitoring system and/or vehicle monitoring system. As another example, remote computing device 110 can be configured to cause an alert to be presented to a user based on the predicted state of the fifth wheel. As yet another example, remote computing device 110 can be configured to communicate instructions to an automated fifth wheel greasing device (e.g., automated fifth wheel greasing device 106) to dispense grease to one or more portions of the fifth wheel based on the predicted state of the fifth wheel.

FIG. 1C shows an example of a vibration-sensor-equipped fifth wheel connected to a trailer 30 in accordance with some embodiments of the disclosed subject matter. As shown in FIG. 1C, trailer 30 can be coupled to fifth wheel 10 by a kingpin 16 of trailer 30, which can be connected to a trailer body 32 via a bolster plate 34. In general, a kingpin (e.g., kingpin 16) can be an integral part of a bolster plate (e.g., bolster plate 34), or can be removably coupled to the bolster plate (e.g., via one or more mechanical fasteners). In the example of FIG. 1C, trailer 30 is pivotally coupled to fifth wheel 10 via kingpin 16, and a portion of the weight of trailer 30 (e.g., a portion not supported by wheels of trailer 30) is transferred to fifth wheel 10 at an interface between a surface of fifth wheel 10 (e.g., top surface 12A) and a surface of bolster plate 34 at an interface 40. During a turn, trailer 30 can pivot with respect to fifth wheel 10, and the relative movement of fifth wheel 10 and bolster plate 34 can cause vibrations (e.g., vibration of fifth wheel 10 and/or within fifth wheel 10). Rotation between trailer 30 and fifth wheel 10 can be facilitated by the presence of grease (and/or any other suitable friction reduction techniques, such as a slick plate comprising high-density polyethylene (HDPE) and/or other friction reducing polymers or materials) at interface 40. As described above, the characteristics of vibration can change based on the state of fifth wheel 10 (e.g., whether a trailer is coupled to fifth wheel 10, whether the trailer is coupled correctly, whether the amount and/or condition of grease is sufficient, etc.). As shown in FIG. 1C, vibration sensor 102 can be coupled to an underside of fifth wheel 10, and vibration sensor 102 can be used to record vibration data to be used to predict a state of fifth wheel 10. Additionally, as shown in FIG. 1C, automated fifth wheel greasing device 106 can be mounted near, and/or to, fifth wheel 10 and can be configured to dispense grease to lubricate interface 40 and/or an interface between kingpin 16 and fifth wheel 10. Note that although mechanisms described herein are generally described in connection with mounting vibration sensor 102 to fifth wheel 10 (e.g., mounted to the underside of fifth wheel 10 as shown in FIG. 1C, and/or mounted to any other suitable portion of fifth wheel 10 such as a flange, gusset, rib, lip, or a cavity provided in a top, bottom, or flange surface, etc.), vibration sensor 102 can be mounted to bolster plate 34 of trailer 30 (e.g., to a bottom surface of bolster plate 34, to a side of bolster plate 34, between bolster plate 34 and trailer body 32, etc.). In such embodiments, local computing device 104 (and/or any other suitable components of a fifth wheel monitoring system) can also be coupled to trailer 30.

In some embodiments, mounting a fifth wheel monitoring system including vibration sensor 102 to trailer 30 can simplify implementation of a machine learning model used to monitor a condition of a fifth wheel coupled to the trailer. For example, if power is provided to the fifth wheel monitoring system from via an electrical connection between the trailer and a tractor, the fifth wheel monitoring system does not generate data unless the trailer is coupled to the fifth wheel, which can facilitate elimination of filtering by the fifth wheel monitoring system to determine whether the fifth wheel is towing a trailer or not towing a trailer (e.g., as described below vibration data collected while not towing a trailer may not be useful for monitoring condition of the fifth wheel). Additionally, in some embodiments, mounting a fifth wheel monitoring system including vibration sensor 102 to trailer 30 can facilitate utilizing a trailer network (e.g., a CAN bus of a trailer, an automotive Ethernet network, etc.) for communication of vibration data and/or fifth wheel condition information. Trailer networks are generally subject to fewer restrictions on data that is communicated than tractor networks (e.g., a CAN bus of a tractor, an automotive Ethernet network, etc.), which generally include many existing sensors that each have a specific designation, which can also limit the amount of data associated with a particular sensor that can be transmitted and/or how often data associated with a particular sensor can be transmitted over the tractor network). Additionally, in some embodiments, mounting a fifth wheel monitoring system including vibration sensor 102 to trailer 30 can facilitate less complex installation as bolster plates do not generally include any moving parts. This can also mitigate a risk of a moving part of a fifth wheel damaging a sensor and/or wire of fifth wheel monitoring system.

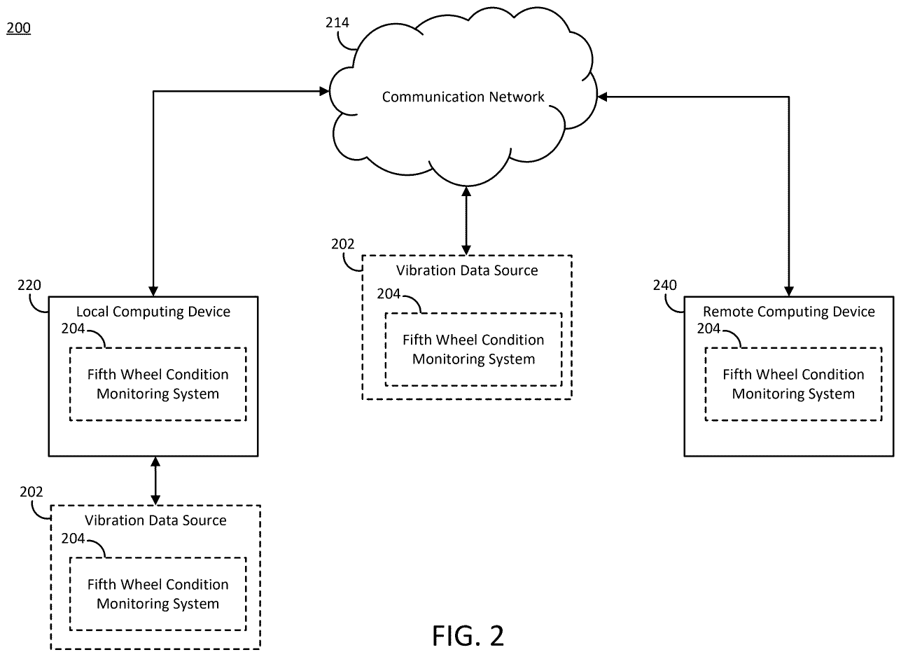

FIG. 2 shows an example of a system 200 for predicting a state of a fifth wheel based on vibration thereof in accordance with some embodiments of the disclosed subject matter. As shown in FIG. 2, a vibration data source 202 can generate vibration data based on vibration of a fifth wheel (e.g., using vibration sensor 102 and/or a computing device that receives data from vibration sensor 102), and can provide the vibration data (e.g., as raw vibration data, processed vibration data, pre-processed vibration data, etc.) to a local computing device 220 and/or a remote computing device 240 directly and/or indirectly using a communication network 214. In some embodiments, local computing device 220 can execute at least a portion of a fifth wheel condition monitoring system 204 to predict a state of a fifth wheel based on vibrations of the fifth wheel (e.g., recorded and/or processed via vibration data source 202). Additionally or alternatively, in some embodiments, vibration data source 202 and/or local computing device 220 can communicate vibration data (e.g., data generated by vibration data source 202) to a remote computing device 240 over communication network 214, and remote computing device 240 can execute at least a portion of fifth wheel condition monitoring system 204 to predict a state of the fifth wheel. Additionally or alternatively, in some embodiments, vibration data source 202 can execute at least a portion of fifth wheel condition monitoring system 204 to predict a state of the fifth wheel, and can communicate vibration data (e.g., raw vibration data, pre-processed vibration data, etc.) and/or results (e.g., a predicted state of the fifth wheel) to local computing device 220 and/or remote computing device 240. In some embodiments, fifth wheel condition monitoring system 204 can execute one or more portions of process 500 described below in connection with FIG. 5 described below in connection with FIG. 5 and/or at least a portion of process 600 described below in connection with FIG. 6. For example, fifth wheel condition monitoring system 204 can be executed by a single computing device (e.g., local computing device 220, remote computing device 240, or vibration data source 202), or can be executed as a distributed system (e.g., a distributed application, a cloud application) across a combination of computing devices (e.g., by local computing device 220, remote computing device 240, vibration data source 202, and/or any other suitable computing device(s)).

In some embodiments, fifth wheel condition monitoring system 204 can receive vibration data (e.g., generated by, and/or received from, vibration data source 202), and can predict a state of a fifth wheel based on the vibration data, either alone, or in combination with any other suitable data from one or more other data sources. For example, local computing device 220 can receive vibration data from vibration data source 202, predict a state of the fifth wheel based on the vibration data. In such an example, local computing device 220 can present information indicative of the predicted state of the fifth wheel (e.g., via an output device of local computing device 220, or via another local output device such as local output device 108). Additionally or alternatively, in such an example, local computing device 220 can transmit information indicative of the predicted state of the fifth wheel (e.g., via communication network 214) to another device (e.g., remote computing device 240).

As another example, local computing device 220 can receive vibration data from vibration data source 202, transmit the vibration data and/or processed vibration data based on the vibration data (e.g., pre-processed vibration data) to remote computing device 240, and remote computing device 240 can predict a state of the fifth wheel based on the vibration data. In such an example, remote computing device 240 can present information indicative of the predicted state of the fifth wheel (e.g., via an output device of remote computing device 240, or via another local output device such as local output device 108). Additionally or alternatively, in such an example, remote computing device 240 can transmit information indicative of the predicted state of the fifth wheel (e.g., via communication network 214) to another device (e.g., back to local computing device 220, to another remote computing device, etc.).

As yet another example, remote computing device 240 can receive vibration data from vibration data source 202 (e.g., via communication network 214), and can predict a state of the fifth wheel based on the vibration data. In such an example, remote computing device 240 can present information indicative of the predicted state of the fifth wheel (e.g., via an output device of remote computing device 240, or via another local output device such as local output device 108). Additionally or alternatively, in such an example, remote computing device 240 can transmit information indicative of the predicted state of the fifth wheel (e.g., via communication network 214) to another device (e.g., local computing device 220, another remote computing device, etc.), which can present the information indicative of the predicted state of the fifth wheel and/or permit access to the information indicative of the predicted state of the fifth wheel.

As still another example, vibration data source 202 can predict a state of the fifth wheel based on the vibration data. In such an example, vibration data source 202 can provide information indicative of the predicted state of the fifth wheel to local computing device 220, remote computing device 240, and/or an output device (e.g., local output device 108), which can present the information indicative of the predicted state of the fifth wheel and/or permit access to the information indicative of the predicted state of the fifth wheel.

In some embodiments, local computing device 220 and/or remote computing device 240 can be any suitable computing device or combination of devices, such as a desktop computer, a laptop computer, a smartphone, a tablet computer, a wearable computer, a server computer, a virtual machine being executed by a physical computing device, an embedded controller (e.g., an electronic control unit), a microcontroller, etc. Laptop computers, smartphones, tablet computers, and wearable computers are all examples of mobile computing devices.

In some embodiments, vibration data source 202 can be any suitable source of vibration data and/or other data that can be used to predict a state of a fifth wheel as described herein. For example, vibration data source 202 can be implemented using one or more vibration sensors (e.g., as described above in connection with vibration sensor 102) configured to measure vibration of, and/or vibration within, a fifth wheel (e.g., fifth wheel 10). As another example, vibration data source 202 can be a computing device(s) and/or data storage device(s) used to collect and/or store vibration data for a fifth wheel being monitored (e.g., raw vibration data, spectrograms, etc.), such as a database server(s), or network storage (e.g., a private storage device connected to network 214, a cloud storage device connected to network 214, etc.). Note that although vibration data source 202 is described in connection with providing vibration data of a fifth wheel, vibration data source 202 can also be a source of other data, such as telematics data (e.g., speed, location, on-board diagnostics, etc.) for a vehicle (e.g., vibration sensor 102 can be connected to a portion of a telematics system), etc.

In some embodiments, vibration data source 202 can be local to local computing device 220 (e.g., physically and logically). For example, vibration data source 202 can be incorporated with local computing device 220 (e.g., vibration data source 202 can be configured as a device or part of a device for capturing, storing, and/or processing fifth wheel vibration data). As another example, vibration data source 202 can be connected to local computing device 220 by a cable, a direct wireless link, etc. Additionally or alternatively, in some embodiments, vibration data source 202 can be located locally and/or remotely from local computing device 220, and can communicate vibration data to local computing device 220 (and/or remote computing device 240) via a communication network (e.g., communication network 214).

In some embodiments, communication network 214 can be any suitable communication network or combination of communication networks. For example, communication network 214 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard(s), such as CDMA, GSM, LTE, LTE Advanced, 5G NR, etc.), a wired network, etc. In some embodiments, communication network 214 can include one or more portions of a local area network (LAN), a wide area network (WAN), a public network (e.g., the Internet, which may be part of a WAN and/or LAN), any other suitable type of network, or any suitable combination of networks. Communications links shown in FIGS. 1A to 3 can each be any suitable communications link or combination of communications links, such as wired links, fiber optic links, Wi-Fi links, Bluetooth links, cellular links, etc.

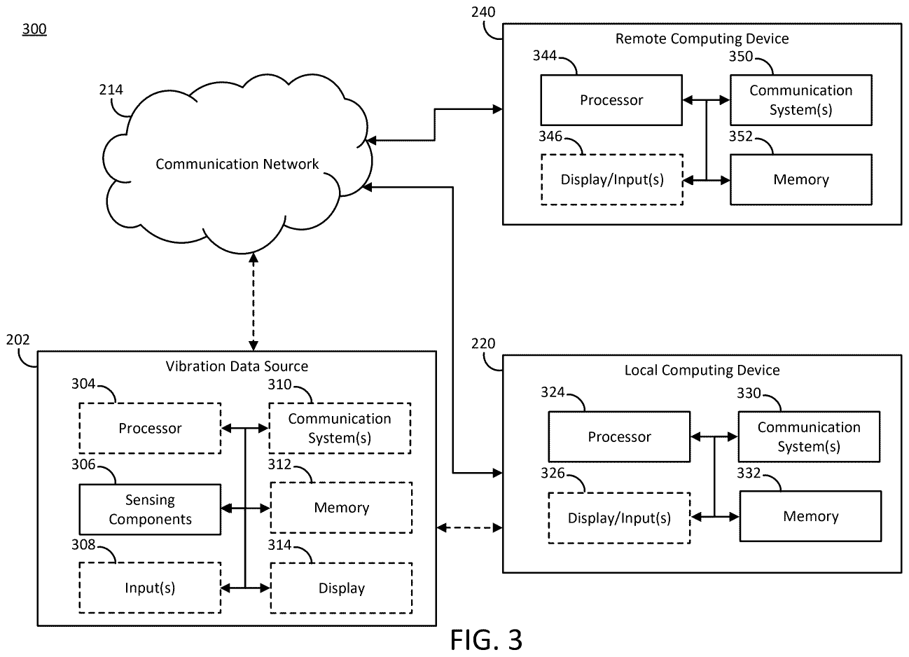

FIG. 3 shows an example of hardware 300 that can be used to implement a vibration data source 202, a local computing device 220, and a remote computing device 240 of FIG. 2 in accordance with some embodiments of the disclosure. As shown in FIG. 3, in some embodiments, vibration data source 202 can include a processor 304, sensing components 306, one or more inputs 308, one or more communication systems 310, memory 312, and/or a display(s) 314.

In some embodiments, processor 304 can be any suitable hardware processor or combination of processors, such as a central processing unit (CPU), an accelerated processing unit (APU), a graphics processing unit (GPU), a field programmable gate array (FPGA), an application specific integrated circuit (ASIC), a microcontroller, etc.

In some embodiments, sensing components 306 can include components that can be used to detect vibrations (e.g., of a vibration sensing component of a vibration sensor) and convert the detected vibrations into electrical signals, such as one or more piezoelectric sensors (and/or any other type of suitable vibration sensing component(s), such as vibration sensing components described above in connection vibration sensor 102 of FIGS. 1A to 1C) that can be used to detect vibrations of a surface and/or object, and/or within a material, that vibration data source 202 is configured to monitor (e.g., along one or more axes). In some embodiments, sensing components 306 can include passive components (e.g., components that do not require an external power source) such as one or more piezoelectric sensors, passive circuit components (e.g., wires, traces, resistors, capacitors, inductors, etc.), and/or one or more active components (e.g., one or more amplifiers, active filters, analog-to-digital converters, digital signal processors, etc.). In some embodiments, a vibration component can be a passive or active component, and a signal produced by the vibration component may or may not be conditioned prior to being recorded (e.g., in memory) and/or output (e.g., via communication system 310).

In some embodiments, inputs 308 can include any suitable input devices and/or sensors that can be used to receive user input, such as a keyboard, a mouse, a touchscreen, a touchpad, a microphone, a camera, etc. In some embodiments, display 314 can include any suitable display devices, such as a touchscreen, a computer monitor, a television, etc. Additionally, vibration data source 202 can include a non-visual output(s) in addition to, or in lieu of, display 314, such as a haptic feedback device, an audio device, etc. In some embodiments, vibration data source 202 can omit sensing components 306, inputs 308, and/or a display(s) 314 (e.g., where vibration data source 202 is not configured for direct user interaction, and/or where vibration data source 202 is a computing device that receives vibration data from a separate vibration sensor, and is not configured for direct user interaction such as a server of a cloud storage service provider).

In some embodiments, communication system(s) 310 can include any suitable hardware, firmware, and/or software for communicating information over a communication network 214 and/or any other suitable communication networks. For example, communication systems 310 can include one or more transceivers, one or more communication chips and/or chip sets, etc., that can be used to establish a wired and/or wireless communication link. In a more particular example, communication systems 310 can include hardware, firmware, and/or software that can be used to establish a direct or indirect wired connection and/or a direct or indirect wireless connection, such as a wired connection (e.g., an analog connection, a digital connection such as a universal serial bus (USB) connection, a controller area network (CAN) bus connection), a Bluetooth connection, Bluetooth Low Energy connection, an ultrawideband (UWB) connection, a ZigBee connection, a Wi-Fi connection, a cellular connection (e.g., an uplink connection, a downlink connection, or a sidelink connection), an Ethernet connection, etc.

In some embodiments, memory 312 can include any suitable storage device or devices that can be used to store instructions, values, etc., that can be used, for example, by processor 304 to perform processes described herein, to detect and/or record data, to store data, to retrieve data, to transmit data, to analyze data, etc., to communicate with local computing device 220 and/or remote computing device 240 via communication system(s) 310, etc. Memory 312 can include any suitable volatile memory, non-volatile memory, storage, or any suitable combination thereof. For example, memory 312 can include random access memory (RAM), read-only memory (ROM), electronically erasable programmable read-only memory (EEPROM), one or more flash drives, one or more hard disks, one or more solid state drives, one or more optical drives, etc.

In some embodiments, memory 312 can have encoded thereon a computer program for controlling operation of vibration data source 202. In such embodiments, processor 304 can execute at least a portion of the computer program to: record raw vibration data in memory 312; process vibration data (e.g., pre-process vibration data as described below); generate one or more condensed representations of the vibration data (e.g., a spectrogram); store condensed representations of the vibration data in memory 312; retrieve vibration data and/or condensed representations of vibration data from storage in memory 312; to transmit information (e.g., raw vibration data, processed vibration data, condensed vibration data, and/or other data) to local computing device 220 and/or remote computing device 240; to execute at least a portion of a process for predicting a state of a fifth wheel based on vibration thereof, such as one or more portions of processes described below in connection with FIGS. 5 and 6, etc.

In some embodiments, local computing device 220 can include a processor 324, a display and/or inputs 326, one or more communication systems 330, and/or memory 332. In some embodiments, processor 324 can be any suitable hardware processor or combination of processors, such as a CPU, an APU, a GPU, an FPGA, an ASIC, a microcontroller, etc.

In some embodiments, display/inputs 326 can include any suitable display devices, such as a computer monitor, a touchscreen, a television, etc., and/or any suitable input devices/sensors that can be used to receive user input, such as a keyboard, a mouse, a touchscreen, a microphone, etc. In some embodiments, local computing system 220 can omit a display and/or inputs (e.g., where local computing system 220 is an embedded device that is not configured for direct user interaction).

In some embodiments, communication systems 330 can include any suitable hardware, firmware, and/or software for communicating information over communication network 214 and/or any other suitable communication networks. For example, communication systems 330 can include one or more transceivers, one or more communication chips and/or chip sets, etc., that can be used to establish a wired and/or wireless communication link. In a more particular example, communication systems 330 can include hardware, firmware, and/or software that can be used to establish a direct or indirect wired connection and/or a direct or indirect wireless connection, such as a wired connection (e.g., an analog connection, a digital connection such as a USB connection, a CAN bus connection), a Bluetooth connection, Bluetooth Low Energy connection, an UWB connection, a ZigBee connection, a Wi-Fi connection, a cellular connection (e.g., an uplink connection, a downlink connection, or a sidelink connection), an Ethernet connection, etc.

In some embodiments, memory 332 can include any suitable storage device or devices that can be used to store instructions, values, etc., that can be used, for example, by processor 324 to perform processes described herein, to receive and/or record data, to store data, to retrieve data, to transmit data, to analyze data, etc., to communicate with vibration data source 202 and/or remote computing device 240 via communication system(s) 330, to receive user input (e.g., via display/inputs 326), to present information and/or a UI to a user (e.g., via display/inputs 326), etc. Memory 332 can include any suitable volatile memory, non-volatile memory, storage, or any suitable combination thereof. For example, memory 332 can include RAM, ROM, EEPROM, one or more flash drives, one or more hard disks, one or more solid state drives, one or more optical drives, etc.

In some embodiments, memory 332 can have encoded thereon a computer program for controlling operation of local computing device 220. In such embodiments, processor 324 can execute at least a portion of the computer program to: receive raw and/or processed vibration data; record raw vibration data in memory 332; process vibration data (e.g., pre-process vibration data as described below); generate one or more condensed representations of the vibration data (e.g., a spectrogram); store condensed representations of the vibration data in memory 332; retrieve vibration data and/or condensed representations of vibration data from storage in memory 332; to transmit information (e.g., raw vibration data, processed vibration data, condensed vibration data, and/or other data) to remote computing device 240 and/or another local computing device; to execute at least a portion of a process for predicting a state of a fifth wheel based on vibration thereof, such as one or more portions of processes described below in connection with FIGS. 5 and 6, etc.

In some embodiments, remote computing device 240 can include a processor 344, a display and/or input(s) 346, a communication system(s) 350, and/or memory 352. In some embodiments, processor 344 can be any suitable hardware processor or combination of processors, such as a CPU, an APU, a GPU, an FPGA, an ASIC, a microcontroller, etc.

In some embodiments, display/input 346 can include any suitable display devices, such as a computer monitor, a touchscreen, a television, etc., and/or can include any suitable input devices and/or sensors that can be used to receive user input, such as a keyboard, a mouse, a touchscreen, a microphone, etc. In some embodiments, remote computing device 240 can omit display/inputs 346 (e.g., where remote computing device 240 is not configured for direct user interaction, such as if remote computing device 240 is a backend device and/or an embedded device).

In some embodiments, communication systems 350 can include any suitable hardware, firmware, and/or software for communicating information over communication network 214 and/or any other suitable communication networks. For example, communication systems 350 can include one or more transceivers, one or more communication chips and/or chip sets, etc., that can be used to establish a wired and/or wireless communication link. In a more particular example, communication systems 350 can include hardware, firmware, and/or software that can be used to establish a direct or indirect wired connection and/or a direct or indirect wireless connection, such as a CAN bus connection, a Bluetooth connection, Bluetooth Low Energy connection, an UWB connection, a ZigBee connection, a Wi-Fi connection, a cellular connection (e.g., an uplink connection, a downlink connection, or a sidelink connection), an Ethernet connection, etc.

In some embodiments, memory 352 can include any suitable storage device or devices that can be used to store instructions, values, etc., that can be used, for example, by processor 344 to perform processes described herein, to receive and/or record data, to store data, to retrieve data, to transmit data, to analyze data, etc., to communicate with vibration data source 202 and/or local computing device 220 via communication system(s) 350, to receive user input (e.g., via display/inputs 346), to present information and/or a UI to a user (e.g., via display/inputs 346), etc. Memory 352 can include any suitable volatile memory, non-volatile memory, storage, or any suitable combination thereof. For example, memory 352 can include RAM, ROM, EEPROM, one or more flash drives, one or more hard disks, one or more solid state drives, one or more optical drives, etc.

In some embodiments, memory 352 can have encoded thereon a computer program for controlling operation of remote computing device 240. In such embodiments, processor 344 can execute at least a portion of the computer program to: receive raw and/or processed vibration data; record raw vibration data in memory 352; process vibration data (e.g., pre-process vibration data as described below); generate one or more condensed representations of the vibration data (e.g., a spectrogram); store condensed representations of the vibration data in memory 352; retrieve vibration data and/or condensed representations of vibration data from storage in memory 352; to transmit information (e.g., raw vibration data, processed vibration data, condensed vibration data, and/or other data) to local computing device 220; to execute at least a portion of a process for predicting a state of a fifth wheel based on vibration thereof, such as one or more portions of processes described below in connection with FIGS. 5 and 6, etc.

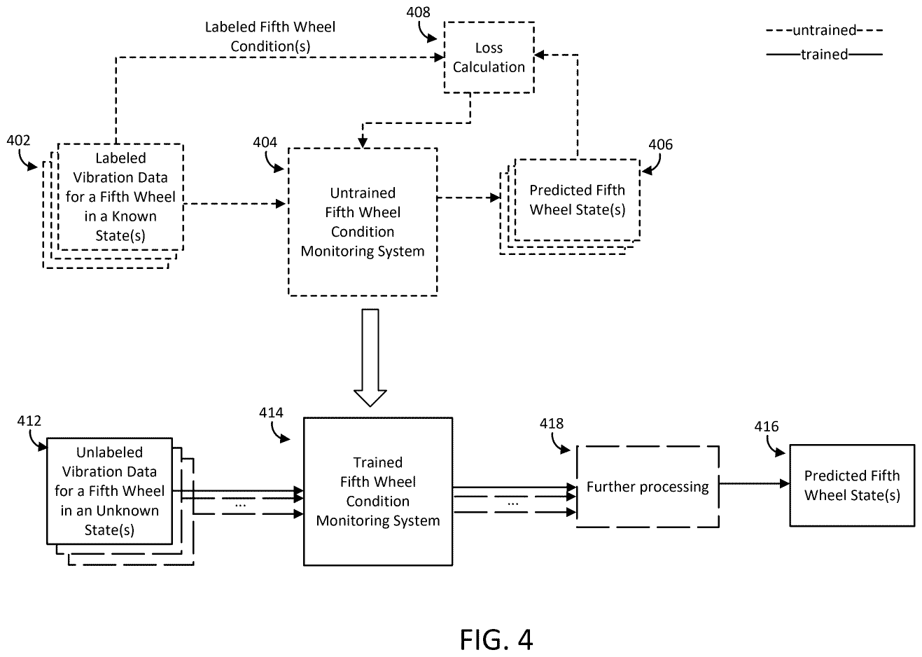

FIG. 4 shows an example of a flow 400 for training and using mechanisms for system for predicting a state of a fifth wheel based on vibration thereof in accordance with some embodiments of the disclosed subject matter. As shown in FIG. 4, labeled vibration data 402 can be used as training data during a training procedure for an untrained fifth wheel condition monitoring system 404. For example, each labeled vibration sample in labeled vibration data 402 can be associated with one or more labels, each indicating a known state of the fifth wheel when the data used to generate the vibration sample was recorded. In such an example, the known state associated with a particular labeled vibration sample can be used as a label during training to determine performance of untrained fifth wheel condition monitoring system 404 during training. In some embodiments, when one or more conditions have been satisfied during training (e.g., a predetermined level of performance has been achieved, a predetermined number of training epochs have been completed, performance improvement between training batches and/or epochs has decreased below a predetermined threshold, etc.), training can be considered complete, and untrained fifth wheel condition monitoring system 404 can be deployed as a trained fifth wheel condition monitoring system 414. Note that labeled vibration data 402 can include data for one particular type and/or configuration of fifth wheel, and/or can include data for multiple different types and/or configurations of fifth wheel. For example, a machine learning model trained using labeled vibration data 402 can be trained for use fifth wheels that are similar to a fifth wheel reflected in the training data (e.g., a fifth wheel from the same manufacturer, a fifth wheel with a similar locking mechanism, etc.). In such an example, multiple machine learning models can be trained using different sets of labeled vibration data associated with different types and/or configurations of fifth wheels, and a machine learning model used to predict a state of a fifth wheel can be selected (e.g., manually via user input or automatically). As another example, a machine learning model trained using labeled vibration data 402 can be trained for use with multiple different types and/or configurations of fifth wheels. In such an example, predictions by such a trained machine learning model can be evaluated for different types and/or configurations of fifth wheels, and the model can be indicated as useable with fifth wheel types and/or configurations for which performance of the trained machine learning model is acceptable (e.g., above a threshold).

In some embodiments, labeled vibration data 402 can be generated using any suitable source of data and/or any suitable technique or combination of techniques. In some embodiments, a vehicle having a fifth wheel that is equipped with one or more vibration sensors (e.g., as described above in connection with vibration sensor 102 of FIGS. 1A to 1C) can be operated (e.g., driven along a route having one or more driving surfaces) under known fifth wheel condition(s), while vibration data is collected using the vibration sensor(s). Additionally, in some embodiments, a locking mechanism of the fifth wheel equipped with one or more vibration sensors can be operated with known fifth wheel conditions while vibration data is collected using the vibration sensor(s). In some embodiments, vibration data collected using the vibration sensor(s) can be labeled based on the known condition(s) of the fifth wheel and/or an operation(s) that was performed while the vibration data was being recorded. In some embodiments, the vibration data can be collected at a particular sampling rate (e.g., 44.1 kilohertz (kHz), 48 kHz, 96 kHz, etc.), and labeled vibration data 402 can represent the collected vibration data at the same rate at which it was collected, or at a different rate. For example, if vibration data is collected at a relatively high sampling rate (e.g., 92 kHz, 96 kHz, or higher), the vibration data can be down sampled to a lower sampling rate (e.g., 10 kHz, 12 kHz, 24 kHz, 48 kHz, etc.), and each labeled vibration sample in labeled vibration data 402 can be based on the down sampled data.

In some embodiments, any suitable condition(s) of the fifth wheel can be varied in connection with generation of labeled vibration data 402. For example, an amount of grease that is present between a top plate of the fifth wheel and a bolster of the trailer can vary during generation of training data. In a more particular example, vibration data can be collected while driving the vehicle equipped with the vibration sensor along one or more routes with a particular level of grease from a discrete set of predetermined levels, such as an excess amount of grease, with a proper amount of grease, with less than a proper amount of grease (e.g., an insufficient amount), and without any grease. As another more particular example, vibration data can be collected while driving the vehicle equipped with the vibration sensor along one or more routes with a level of grease in a range of levels, such as from no grease (e.g., a completely unlubricated interface) to an excessive amount of grease, and any level therebetween.

As another example, an amount of grease that is present in a locking mechanism of the fifth wheel can vary during generation of the training data. In a more particular example, vibration data can be collected while locking and unlocking the locking mechanisms, coupling and decoupling a trailer, while driving along a route(s), etc., with a particular level of grease from a discrete set of predetermined levels, and/or a level within g a range of levels.

As yet another example, whether the fifth wheel is coupled to a trailer, and/or the mass of the trailer (e.g., the unloaded mass, the mass with a predetermined load, etc.), can vary during generation of the training data.

As still another example, the location of the vibration sensor collecting the data, the type of vibration sensor used to collect the data, the mechanism used to secure the vibration sensor to the fifth wheel, and/or other variables associated with the vibration sensor, can be varied during generation of training data. In such an example, data associated with different vibration sensor positions, types, etc., can be collected in parallel (e.g., via multiple vibration sensors coupled to the fifth wheel simultaneously while the vehicle and/or fifth wheel is being operated, via vibration sensors coupled to fifth wheels of different vehicles that are operated concurrently), and/or serially (e.g., via replacement of a vibration sensor(s), via replacement of a fifth wheel equipped with vibration sensors at different locations, of different types, etc.). Note that one or more other conditions, in addition to, or in lieu of, an example(s) described above, can also be varied during collection of the training data that may impact characteristics of the collected vibration data.

In some embodiments, a value representing a condition of the fifth wheel and/or vehicle can be represented using any suitable type of variable and/or label, such as a Boolean variable, a discrete variable, and/or a continuous variable. For example, an amount of grease that is present between a top plate of the fifth wheel and a bolster of the trailer can be represented using a Boolean variable (e.g., true if the amount of grease is sufficient or false if insufficient); a discrete variable (e.g., representing an amount of grease as a fraction of a proper amount of grease, for example, as a percentage or decimal value with 0% or 0.00 representing no lubrication, 100% or 1.00 representing proper lubrication, and values larger than 100%/1.00 representing an amount of grease that exceeds the proper amount of lubrication); and/or a continuous variable (e.g., representing an amount of grease as a mass and/or volume of grease that is present).

As another example, an amount of grease that is present in a locking mechanism of the fifth wheel can be represented using a Boolean variable, a discrete variable, and/or a continuous variable.

As yet another example, whether the fifth wheel is coupled to a trailer can be represented using a Boolean variable (e.g., true if a trailer is coupled or false if no trailer is coupled); a discrete variable (e.g., representing a mass of a trailer that is coupled to the fifth wheel as a fraction of a maximum rated weight of the fifth wheel, for example, as a percentage or decimal value with 0% or 0.00 representing no trailer coupled to the fifth wheel, 100% or 1.00 representing a maximum rated load, and values larger than 100%/1.00 representing an excessive load); and/or a continuous variable (e.g., representing a mass of a trailer, if any, coupled to the fifth wheel).

In some embodiments, labeled vibration data 402 can include examples generated from recorded samples with one or more data augmentation techniques applied. For example, augmenting vibration data can include adding noise at one or more frequencies, reordering of portions of the sample (e.g., timeshifting), zeroing out a portion of the sample (e.g., all frequencies for a particular time bin of a spectrogram, all times for a particular frequency bin of a spectrogram), etc. Note that augmentation can be performed on raw vibration data prior to any pre-processing, and/or on pre-processed vibration data (e.g., a sample of raw vibration data can be augmented, and/or a spectrogram generated from a sample of vibration data can be augmented).

In some embodiments, untrained fifth wheel condition monitoring system 404 can include one or more machine learning models having weights and/or hyperparameters that can be varied during a training process that is used to train the one or more machine learning models to predict a condition(s) of a fifth wheel, and trained fifth wheel condition monitoring system 414 can include one or more machine learning models trained to predict a condition(s) of a fifth wheel, having weights and/or hyperparameters with values that were determined during a training process.

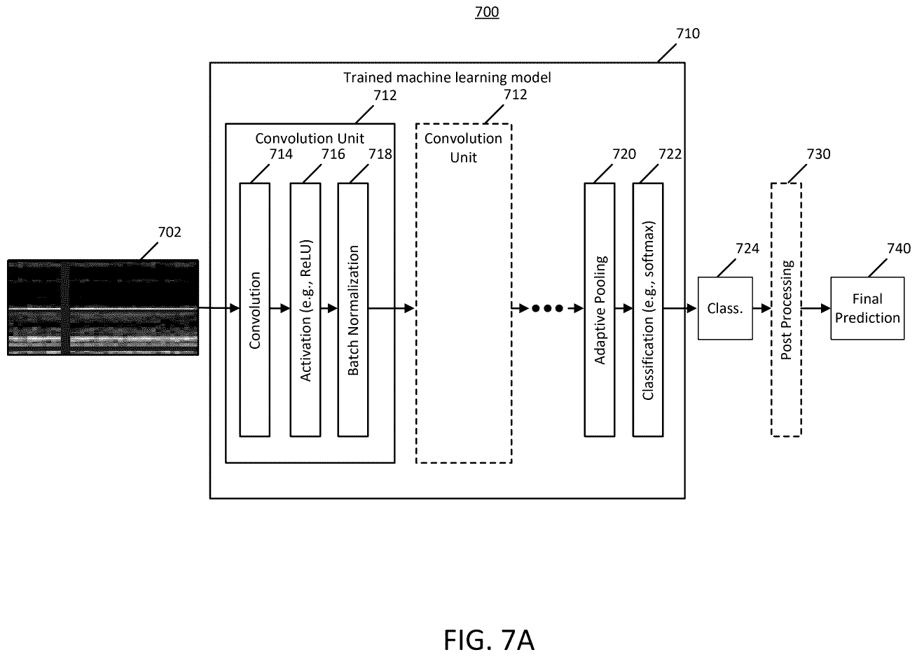

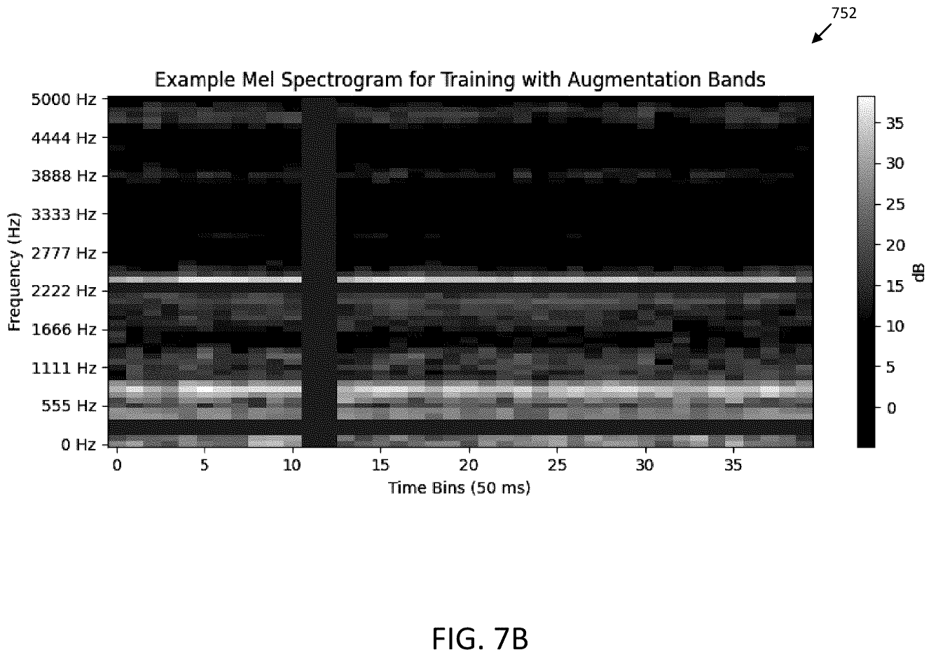

For example, as described below in connection with FIG. 7, untrained fifth wheel condition monitoring system 404 and/or trained fifth wheel condition monitoring system 414 can include a classification model that takes a sample of vibration data collected from a fifth wheel, and/or a representation of the sample of vibration data, as input, and outputs a predicted classification(s) of the fifth wheel among a set of classes. As another example, untrained fifth wheel condition monitoring system 404 and/or trained fifth wheel condition monitoring system 414 can include a regression model that takes a sample of vibration data (or representation thereof) collected from a fifth wheel as input, and outputs a predicted state(s) of the fifth wheel (e.g., within a range). In such examples, a sample of vibration data can be a predetermined amount of raw or processed vibration data from a stream of vibration data received from a vibration sensor, such as vibration sensor 102, and/or a vibration data source, such as vibration data source 202. A representation of a sample of vibration data can be a spectrogram, or other suitable representation, of the information encoded within a predetermined amount of vibration data. Note that although examples described herein are most often described in connection with predicting a lubrication condition of the fifth wheel, untrained fifth wheel condition monitoring system 404 and/or trained fifth wheel condition monitoring system 414 can include a machine learning model(s) configured to use vibration data collected from a fifth wheel to predict whether the fifth wheel is in (and/or not in) a particular operating state (e.g., whether the locking mechanisms is properly locked, whether the locking mechanisms is fully unlocked, whether the locking mechanism is jammed, whether a kingpin is properly coupled to the fifth wheel, whether the fifth wheel is properly secured to the tractor, etc.) and/or to predict a maintenance condition of at least a portion of the fifth wheel (e.g., a wear state of the top plate, a wear state of the locking mechanism, etc.). Such a machine learning model may be in addition to, or in lieu of, a machine learning model trained to predict a lubrication condition of the fifth wheel.

In some embodiments, untrained fifth wheel condition monitoring system 404 and/or trained fifth wheel condition monitoring system 414 can be configured to pre-process input vibration data to generate a suitable representation (s of the vibration data that can be input to the machine learning model(s). In such an example, pre-processing can include extracting a predetermined amount of vibration data from received vibration data (e.g., a stream of vibration data) as a sample to be analyzed, conditioning the vibration data (e.g., normalizing the data based on amplitudes within the sample, applying one or more filters, amplifying one or more portions of a received signal, etc.), and/or generating a spectrogram from the sample of vibration data to be analyzed. Additionally or alternatively, in some embodiments, untrained fifth wheel condition monitoring system 404 and/or trained fifth wheel condition monitoring system 414 can be configured to receive pre-processed vibration data (e.g., a sample of raw vibration data, a sample or stream of conditioned vibration data, a spectrogram generated from a sample of raw or condition vibration data, etc.) which can be used as input to the machine learning model(s) and/or which can be further processed to be suitable as input to the machine learning model(s).

In some embodiments, the machine learning model(s) included in untrained fifth wheel condition monitoring system 404 can have any suitable architecture, topology, and/or hyperparameters, and can be trained using any suitable technique or combination of techniques. Additionally, in some embodiments, training of untrained fifth wheel condition monitoring system 404 can include tuning of any suitable hyperparameters and/or weights associated with the machine learning model(s) included in untrained fifth wheel condition monitoring system 404.

In some embodiments, during training, untrained fifth wheel condition monitoring system 404 can generate a predicted state of the fifth wheel 406 corresponding to each labeled example in the set of labeled vibration data 402. For example, each prediction 406 can include a classification indicative of one particular class of a set of classes, such as a highest probability class (e.g., an identification of one particular class), that corresponds to the predicted current state of the fifth wheel. As another example, each prediction 406 can include a set of confidence scores indicative of a probability that the current state of the fifth wheel is an example of each class of a set of classes. In such an example, a linear activation function (e.g., a softmax activation function) can be used to map outputs of a classifier to a set of confidence scores. As yet another example, each prediction 406 can include a set of logits indicative of a probability that the current state of the fifth wheel is an example of each class of a set of classes. In such an example, the logits can be outputs of a non-linear activation layer, or based on outputs of a non-linear activation layer. As still another example, prediction 406 can include a value indicative of a predicted state(s) of the fifth wheel within a range of values indicative of an amount of grease (e.g., a grease level between unlubricated and adequately lubricated, or another value such as excessively lubricated), and/or indicative of a level of lubrication being provided by the grease and/or other friction reducing material (e.g., grease can become less effective at reducing friction over time as water, dirt, etc., becomes trapped in the grease, and/or as the grease is displaced from the surface(s) that is to be lubricated).

In some embodiments, at 408, each prediction 406 output during training of untrained fifth wheel condition monitoring system 404 can be used to calculate a value (e.g., a loss value) that can be used to evaluate performance of untrained fifth wheel condition monitoring system 404, which can be used to tune weights of untrained fifth wheel condition monitoring system 404 (and/or other values, such as hyperparameters) to improve performance of untrained fifth wheel condition monitoring system 404 over time (e.g., over multiple batches, epochs, etc.). Additionally, a subset of labeled vibration data 402 can be reserved as test data (e.g., data not used in active training, and used to evaluate performance during training).

In some embodiments, trained fifth wheel condition monitoring system 414 (e.g., resulting from the training of untrained fifth wheel condition monitoring system 404) can be used to generate a predicted fifth wheel state(s) 416 indicative of a predicted current state of the fifth wheel when a particular sample of unlabeled vibration data 412 collected from a fifth wheel was generated. For example, unlabeled vibration data 412 can be generated by a vibration sensor (e.g., vibration sensor 102) associated with a fifth wheel in an unknown condition (e.g., with an unknown amount of grease) that is being monitored. In such an example, trained fifth wheel condition monitoring system 414 can generate predicted fifth wheel state(s) 416 indicative of a predicted current condition of the fifth wheel, which can be used to determine whether to alert an operator of the vehicle associated with the fifth wheel to the current condition (e.g., to alert the operator that lubrication at the interface between the top plate of the fifth wheel and the trailer is insufficient), allow a user (e.g., the operator of the vehicle, a fleet operator, etc.) to monitor a current condition of the fifth wheel, operate a device that can augment the state of the fifth wheel (e.g., an automated greasing device, such as automated fifth wheel greasing device 106 that can be controlled to dispense grease to one or more portions of the fifth wheel when the level of grease is predicted to be insufficient, and can be inhibited from dispense grease to one or more portions of the fifth wheel when the level of grease is predicted to be sufficient), etc. In some embodiments, predicted fifth wheel state(s) 416 can be a classification(s) and/or a value indicative of the predicted state (e.g., as described above in connection with predictions 406).

In some embodiments, predicted fifth wheel state(s) 416 can be based on multiple outputs of trained fifth wheel condition monitoring system 414, which can potentially increase the accuracy of final predictions. For example, as shown in FIG. 4, further processing can be performed, at 418, to generated predicted fifth wheel state(s) 416 based on multiple predictions generated by trained fifth wheel condition monitoring system 414, such as a series of outputs corresponding to a series of vibration data samples generated over time. Additional examples of additional processing techniques that can be used to generate a predicted fifth wheel state are described below in connection with FIG. 5.

FIG. 5 shows an example of a process 500 for predicting a state of a fifth wheel based on vibration thereof in accordance with some embodiments of the disclosed subject matter.

At 502, process 500 can receive vibration data recorded by a vibration sensor mounted to a fifth wheel. In some embodiments, process 500 can receive vibration data from any suitable source, using any suitable technique or combination of techniques. For example, process 500 can receive vibration data directly from a vibration sensing component of a vibration sensor as vibrations are detected (e.g., as an analog signal present on a wire(s) connected to the vibration sensing component). As another example, process 500 can receive vibration data from signal conditioning components of the vibration sensor as vibrations are detected (e.g., as an analog or digital signal present on a wire(s) connected to the signal conditioning components). As yet another example, process 500 can receive a stream of vibration data from a processor(s) of the vibration sensor (e.g., a microcontroller of a vibration sensor) via a communication link(s) with the processor (e.g., as a digital signal transmitted via the communication link(s)) in real-time as the processor receives a signal from a vibration sensing component and/or signal conditioning components. As still another example, process 500 can receive a file (e.g., an audio file) that includes vibration data from a vibration data source (e.g., vibration data source 202) that stored the file in memory.

In some embodiments, generation of vibration data using a vibration sensor(s) can be relatively continuous, or can be periodic (e.g., at regular and/or irregular intervals). For example, a vibration sensor (e.g., vibration sensor 102) can be configured to generate vibration data based on vibrations of a fifth wheel substantially continuously. In such an example, the vibration sensor can be a passive sensor that is configured to generate and output electrical signals in response to vibrations regardless of whether power is being provided, or can be an active sensor (e.g., including a passive sensor equipped with a pre-amplifier) that is configured to generate and output electrical signals in response to vibrations when receiving power. As another example, a vibration sensor (e.g., vibration sensor 102) can be configured to generate vibration data periodically at regular intervals. In such an example, the vibration sensor can be operated at any suitable interval, which can vary depending on the condition(s) that is being monitored, and how quickly the condition may change. As yet another example, a vibration sensor (e.g., vibration sensor 102) can be configured to generate vibration data in response to occurrence of an event. In such an example, the vibration sensor can be operated in response to an event that is likely to be associated with a change in a condition (e.g., when a trailer is coupled or uncoupled from the fifth wheel, when a locking mechanism of the fifth wheel is operated, etc.), and/or in response to an event that is associated with more accurate results (e.g., if results are more accurate when the vehicle is moving within a predetermined range of speeds).

In some embodiments, recording of generated vibration data can be relatively continuous, or can be periodic (e.g., at regular and/or irregular intervals). For example, a device configured to record vibration data output from a vibration sensor (e.g., vibration sensor 102) can be configured to record all data output by the vibration sensor in memory (e.g., a buffer, volatile memory, non-volatile memory). As another example, a device configured to record vibration data output from a vibration sensor (e.g., vibration sensor 102) can be configured to record vibration data periodically at regular intervals. In such an example, vibration data that is output from the vibration sensor can be recorded during some periods of time, and can be disregarded during other periods of time. As yet another example, a device configured to record vibration data output from a vibration sensor (e.g., vibration sensor 102) can be configured to record vibration data in response to occurrence of an event.

In some embodiments, analysis of vibration data can be relatively continuous, or can be periodic (e.g., at regular and/or irregular intervals). For example, process 500 can pre-process vibration data (e.g., at 504) and analyze the vibration data (e.g., at 506 to 510) as vibration data is received at 502. As another example, process 500 can pre-process vibration data (e.g., at 504) and analyze the vibration data (e.g., at 506 to 510) periodically at regular intervals. As yet another example, process 500 can pre-process vibration data (e.g., at 504) and analyze the vibration data (e.g., at 506 to 510) in response to occurrence of an event.

At 504, process 500 can pre-process a predetermined portion of the received vibration data for input to a trained machine learning model for predicting a state of a fifth wheel based on vibration thereof. In some embodiments, pre-processing at 504 can include any suitable technique or combination of techniques to transform vibration data received at 502 into a format that is suitable for input to a machine learning model(s) trained to predict a state of a fifth wheel based on vibration of the fifth wheel. For example, process 500 can use techniques described below in connection with FIG. 6 to pre-process vibration data. As another example, process 500 can generate a representation of the change in frequency components of vibration data encoded as an audio signal over time. In such an example, the representation can be generated with particular dimensions, such as a particular length (e.g., in time bins) and a particular height (e.g., in frequency bins), that correspond to the dimensions of training data used to train the machine learning model.

At 506, process 500 can provide the pre-processed vibration data as input to a machine learning model trained to predict a state of a fifth wheel based on vibration thereof. For example, process 500 can provide the pre-processed vibration data to a machine learning model described above in connection with trained fifth wheel condition monitoring system 414 of FIG. 4.

At 508, process 500 can receive, from the trained machine learning model, an output indicative of a predicted state of the fifth wheel when the predetermined portion of the vibration data was recorded. In some embodiments, output indicative of the predicted state of the fifth wheel can include a classification(s) and/or a value indicative of a current predicted state of the fifth wheel (e.g., as described above in connection with predictions 406 and 416 of FIG. 4).

In some embodiments, if multiple samples of vibration data are created from a single longer sample and analyzed concurrently (e.g., as described below in connection with process 600 of FIG. 6), each prediction outputted concurrently can be treated as a separate output indicative of the predicted state of the fifth wheel, or the output can be based on a consensus of the multiple predictions (e.g., the output can be whichever class was predicted most often among the multiple predictions generated concurrently, can be whichever class was predicted most often with at least a threshold confidence among the multiple predictions generated concurrently, can based on an average confidence of each class, etc.). For example, if each sample provided as input to the trained machine learning is based on a two second audio clip of vibration data, and a received sample is about 16 seconds long, the longer sample can be used to generate eight inputs for the machine learning model (e.g., eight spectrograms), which can be used to generate eight predictions (e.g., substantially in parallel). In such an example, the output received at 508 can include all eight of the predictions, or can be fewer predictions (e.g., a single prediction, or multiple predictions) based on the eight predictions.

At 510, process 500 can generate a final prediction of the current state of the fifth wheel based on one or more outputs of the trained machine learning model. In some embodiments, process 500 can use any suitable technique or combination of techniques to generate a final prediction based on one or more outputs of the trained machine learning model, which can be configured to improve an accuracy of the prediction, and/or decrease volatility of predictions over relatively short periods of time. For example, process 500 can determine whether a particular prediction received from the trained machine learning model is reliable (e.g., based on a confidence value associated with the prediction, based on a comparison of a particular predicted state to an average predicted state over a predetermined period of time). As another example, process 500 can determine the final prediction based on a set of relatively recent predictions (e.g., based on which class was predicted the greatest number of times, based on an average of values indicative of the current predicted state of the fifth wheel). In some embodiments, process 500 can omit 510 (e.g., if a single prediction of the trained machine learning model is always to be used).

In some embodiments, if a classification(s) is output from the trained machine learning model (e.g., if the trained machine learning model is a classification model), process 500 can record a predetermined number of predictions generated over a predetermined period of time (e.g., corresponding to about ten seconds, twenty seconds, thirty seconds, a minute, etc.), and can evaluate the set of predictions to determine the final prediction. For example, process 500 can determine which classification was predicted with the highest probability most often during the predetermined period of time, and can select that class as the final prediction. In a more particular example, if all predictions in the set of predictions are the same (e.g., sufficiently greased or insufficiently greased was always the highest probability class output from a machine learning model trained to output likelihoods that the vibration data in the input was an example of each of two classes corresponding to sufficiently greased and insufficiently greased), process 500 can select that class as the final prediction. As another more particular example, if all predictions in the set of predictions are a particular class (e.g., sufficiently greased), process 500 can select that class as the final prediction (e.g., even if the classification values of all of the predictions are relatively low confidence).

As another example, process 500 can determine whether a particular class was predicted with the highest probability at least a predetermined number of times within the predetermined period of time (e.g., at least a threshold number of times), or at least a predetermined proportion of the predetermined period of time (e.g., the portion of the predetermined period of time predicted as the particular class compared to the total length of the predetermined period of time). In such an example, if no class was predicted a sufficient number of times or proportion of the predetermined period of time, the final prediction can be a most recent final prediction that was based on a class that was predicted a sufficient number of times or proportion within the predetermined period of time.

In some embodiments, predicted classifications output by the trained machine learning model can be disregarded and/or given less weight if the confidence of the prediction is below a threshold. For example, for a classification model that outputs a value indicative of a likelihood of membership in each class, process 500 can disregard the prediction if the higher probability class is less than a threshold (e.g., about 55%, 60%, 65%, 70%, etc.).

In some embodiments, if a predicted state is output from the trained machine learning model (e.g., if the trained machine learning model is a regression model), process 500 can record a predetermined number of predictions generated over a predetermined period of time (e.g., corresponding to about ten seconds, twenty seconds, thirty seconds, a minute, etc.), and can evaluate the set of predictions to determine the final prediction. For example, process 500 can calculate an average (e.g., a simple average or a weighted average) of the predictions over the predetermined period of time.

In some embodiments, a predicted state output by the trained machine learning model can be disregarded and/or given less weight if the value of the predicted state is an outlier (e.g., is more than a predetermined number of standard deviates from the average). For example, for a regression model that outputs a value indicative of a predicted state, process 500 can disregard a prediction if the value is more than a standard deviation from the average (or more, such as 1.5 standard deviations, two standard deviations, etc.).

In some embodiments, one or more additional inputs can be used to determine whether a final prediction is reliable, and/or to adjust a value of the final prediction. For example, process 500 can determine whether a value of a fifth wheel locking indicator is consistent with the final prediction (e.g., if the fifth wheel has been locked, a rapid change in a level of grease may be unlikely), and/or process 500 can adjust the final prediction based on a value of the fifth wheel locking indicator (e.g., if the fifth wheel locking indicator indicates that the fifth wheel has recently been unlocked and locked, the value of the final prediction can be adjusted to change from a final prediction value before the fifth wheel was unlocked until a sufficient amount of vibration data has been collected). As another example, process 500 can determine that an output of a trained machine learning model that predicts whether the fifth wheel is properly greased is to be disregarded if another data source indicates that there is not a trailer coupled to the fifth wheel.

In some embodiments, a user can be permitted to provide input that causes a final prediction to be adjusted (e.g., scaled). For example, a user can provide input indicating that the fifth wheel is properly greased, and the final output can be scaled based on the prediction output by the trained model (e.g., if the model predicts that the fifth wheel is 70% greased when the user indicates that the fifth wheel has been properly greased, process 500 can scale predictions of the model using 70% as a baseline).

At 512, process 500 can determine whether to provide the predicted state of the fifth wheel to a user. In some embodiments, process 500 can use any suitable technique or combination of techniques to determine whether to provide the predicted state of the fifth wheel to a user. For example, in some embodiments, process 500 can determine that the predicted state of the fifth wheel is to be provided to a user if the predicted state is associated with a state that is likely to be dangerous and/or is likely to cause damage or premature wear to the fifth wheel, trailer, and/or another component of the vehicle. As another example, process 500 can determine that the predicted state of the fifth wheel is to be provided to a user if the predicted state has changed relatively quickly. As yet another example, process 500 can determine that the predicted state of the fifth wheel is to be provided to a user if a predetermined event has occurred relatively recently (e.g., a trailer has been uncoupled from the fifth wheel and/or a trailer has been coupled to the fifth wheel). As still another example, process 500 can determine that the predicted state of the fifth wheel is to be provided to a user if the predicted state satisfies a condition (e.g., a condition set by a user).

Additionally or alternatively, in some embodiments, process 500 can determine whether to operate a device configured to augment the state of the fifth wheel based on the predicted state of the fifth wheel at 512. For example, in some embodiments, process 500 can determine that an automated fifth wheel greasing device (e.g., automated fifth wheel greasing device 106) is to be controlled to dispense grease to one or more portions of the fifth wheel based on a predicted class of a greased state of the fifth wheel (e.g., if the predicted class indicates that the fifth wheel is insufficiently greased) and/or a predicted value of the greased state of the fifth wheel (e.g., if the predicted grease level has fallen below a threshold).

If process 500 determines that the predicted state is not to be presented to the user(s) (“NO” at 514), process 500 can return to 502. For example, process 500 can continue to monitor a condition(s) of the fifth wheel until a predetermined event occurs that causes the predicted state to be provided to the user.

Otherwise, if process 500 determines that the predicted state is to be presented to the user(s) (“YES” at 514), process 500 can move to 516.

At 516, process 500 can cause a predicted state of the fifth wheel to be presented to one or more users. In some embodiments, process 500 can use any suitable technique or combination of techniques to cause the predicted state of the fifth wheel to be presented to one or more users. For example, process 500 can use techniques described above in connection with FIGS. 1A to 1C to cause the predicted state of the fifth wheel to be presented by one or more user interface devices (e.g., an output of a local computing device such as local computing device 104, a local output device such as local output device 108).

Additionally or alternatively, in some embodiments, process 500 can operate a device configured to augment the state of the fifth wheel at 516 based on the predicted state of the fifth wheel (e.g., at 508 and/or 510). For example, in some embodiments, process 500 can cause an automated fifth wheel greasing device (e.g., automated fifth wheel greasing device 106) to dispense grease to one or more portions of the fifth wheel based the predicted state of the fifth wheel (e.g., at 508 and/or 510). In a more particular example, process 500 can cause the automated fifth wheel greasing device to dispense a predetermined amount of grease in response to the predicted class indicating that the fifth wheel is insufficiently greased. In such an example, if the predicted class continues to indicate that the fifth wheel is insufficiently greased after the automated fifth wheel greasing device has been instructed to dispense grease, process 500 can cause the automated fifth wheel greasing device to dispense additional grease and/or can cause a user to be alerted to the predicted state of the fifth wheel (and/or to be alerted to a potential failure of the automated fifth wheel greasing device). As another more particular example, process 500 can cause the automated fifth wheel greasing device to dispense a predetermined amount of grease if the predicted grease level has fallen below a threshold, or can cause the automated fifth wheel greasing device to dispense an amount of grease that is expected to cause the grease level to rise to a predetermined level. In such an example, if the predicted grease level fails to increase and/or does not increase sufficiently (e.g., by a sufficient amount and/or to a predetermined sufficient level) after the automated fifth wheel greasing device has been instructed to dispense grease, process 500 can cause the automated fifth wheel greasing device to dispense additional grease and/or can cause a user to be alerted to the predicted state of the fifth wheel (and/or to be alerted to a potential failure of the automated fifth wheel greasing device).

In some embodiments, process 500 can omit 512 to 516. For example, if predictions output by a trained machine learning model are provided to a computing device associated with the user (e.g., a local computing device in communication with a device executing at least a portion of process 500, a remote computing device in communication with a device executing at least a portion of process 500), and the computing device is configured to present predictions about a condition of the fifth wheel to a user (e.g., to provide access to predictions, to generate alerts based on predictions, etc.).

FIG. 6 shows an example of a process 600 for pre-processing vibration data in accordance with some embodiments of the disclosed subject matter.

At 602, process 600 can receive a sample of a signal recorded by a vibration sensor mounted to a fifth wheel during a particular period of time. In some embodiments, process 600 can receive the sample in any suitable format, and can be received from any suitable source. For example, the sample can be in an audio format in which detected vibrations of a fifth wheel are encoded as an amplitude signal that varies over time.

At 604, process 600 can adjust a length of the received sample to a predetermined length if a period of time represented by the sample does not correspond to the predetermined length of time. In some embodiments, process 600 can determine whether a length of the sample is equal to a predetermined length (e.g., in time, data points, etc.). For example, if a machine learning model trained to predict a state of a fifth wheel based on vibrations of the fifth wheel was trained using samples that represented a predetermined length of time (e.g., one second, two seconds, etc.), process 600 can determine whether the received sample represents the same length of time.

In some embodiments, if the length of the sample does not correspond to the predetermined length of time, process 600 can adjust a length of the sample. For example, if the sample is longer than the predetermined period of time, process 600 can delete one or more portions of the sample (e.g., from the beginning, from the end, from the beginning and end, etc.) to shorten the sample to the predetermined length. As another example, if the sample is shorter than the predetermined period of time, process 600 can add data additional vibration data to the sample (e.g., at the beginning, at the end, at the beginning and end, etc.) to lengthen the sample to the predetermined length. In such an example, process 600 can pad the sample with zeros (e.g., corresponding to silence).

Additionally or alternatively, in some embodiments, if the received sample is more than twice the predetermined length, process 600 can generate multiple samples that are each the predetermined length from the longer sample. For example, a trained fifth wheel condition monitoring system may be configured to analyze on batches of samples in parallel, and process 600 can divide a longer sample into a number of samples that are suitable for parallel analysis by the trained fifth wheel condition monitoring system.

At 606, process 600 can adjust a sampling frequency of the received sample to a predetermined sampling frequency if the sample was recorded and/or received at another sampling frequency. In some embodiments, process 600 can determine whether a sampling rate of the sample is equal to a predetermined sampling rate (e.g., in kilohertz (kHz)). For example, if a machine learning model trained to predict a state of a fifth wheel based on vibrations of the fifth wheel was trained using vibration data samples encoded at a predetermined sampling rate (e.g., 10 kHz, 12 kHz, 24 kHz, 44.1 kHz, 48 kHz, 92 kHz, 96 kHz, etc.), process 600 can determine whether the received sample is encoded at the predetermined sampling rate. As another example, if a machine learning model trained to predict a state of a fifth wheel based on vibrations of the fifth wheel was trained using a representation of components of the vibration data in the frequency domain (e.g., a frequency domain representation, such as a spectrogram) generated from data encoded at a predetermined sampling rate, (e.g., 10 kHz, 12 kHz, 24 kHz, 44.1 kHz, 48 kHz, 92 kHz, 96 kHz, etc.), process 600 can determine whether the received sample is encoded at the predetermined sampling rate. As yet another example, if a computing device that is to be used to generate a frequency domain representation of the vibration data has limited compute resources, reducing the sampling rate can reduce the amount of compute resources needed to, and/or used to, generate a frequency domain representation from time domain vibration data.

In some embodiments, if the sample rate of the sample does not correspond to the predetermined length of time, process 600 can adjust the sample rate of the sample. For example, if the sample vibration data is encoded at a higher sample rate, process 600 can reduce the sample rate (e.g., by subsampling or downsampling the sample) to the predetermined sample rate. As another example, if the sample vibration data is encoded at a lower sample rate than the predetermined sample rate, process 600 can increase the sample rate (e.g., using conventional audio upsampling techniques and/or audio upsampling techniques that incorporate machine-learning).

In some embodiments, process 600 can omit 604 and/or 606. For example, if the vibration data sample is the predetermined length and/or is encoded at the predetermined sample rate. Additionally, process 600 can perform one or more other operations to match characteristics of the vibration data sample to characteristics of training data, such as a bit depth used to encode the signals.

At 608, process 600 can generate a frequency domain representation of frequency components of the sample over at least a portion of the predetermined length of time. In some embodiments, process 600 can use any suitable technique or combination of techniques to generate a frequency domain representation of the sample, which can be in any suitable format. For example, process 600 can use one or more time-frequency transform techniques to generate a spectrogram that represents the amplitude of different frequencies in the signal over time. In a more particular example, process 600 can use fast Fourier transform (FFT) techniques, Stockwell transform (S transform) techniques, and/or any other suitable technique to determine the frequency components present in the vibration data sample at different points in time.

In some embodiments, process 600 can generate a spectrogram that is formatted as an image for which one axis (e.g., the x-axis) represents time, the other axis (e.g., the y-axis) represents frequency, and a value of a pixel (e.g., a brightness value, chrominance and luminance values, RGB values, etc.) represents the amplitude of a specific frequency or range of frequencies in the vibration data sample at a particular time (or over a particular period of time). In some embodiments, such a spectrogram image can be provided as input to a machine learning model configured to analyze image data. In some embodiments, the time bins and/or frequency bins can be uniformly sized (e.g., the frequency range in the vibration data can be evenly divided into equal sized frequency bins). Alternatively, in some embodiments, the range of frequencies in different frequency bins can be different (e.g., based on the mel scale).

FIG. 7A shows an example of a high level architecture 700 of a machine learning model that can be used to implement mechanisms for predicting a state of a fifth wheel based on vibration thereof in accordance with some embodiments of the disclosed subject matter. As shown in FIG. 7A, a spectrogram 702 representing a sample of vibration data from a fifth wheel (e.g., as described above in connection with FIG. 6) can be provided as input to a trained machine learning model 710 for predicting a state of the fifth wheel. In some embodiments, spectrogram 702 can be provided to trained machine learning model 710 using two input channels of trained machine learning model 710. For example, the two input channels of trained machine learning model 710 can be configured to receive spectrogram data generated from different channels (e.g., a left channel and a right channel of a stereo audio signal). In a more particular example, the two channels can represent the same vibration data (e.g., if spectrogram 702 is generated from a mono channel audio signal, the information in the mono channel audio signal can be cloned to provide data for a second channel). In such an example, the data provided via the first channel and the data provided via the second channel can be identical. As another more particular example, the two channels can represent vibration data collected using multiple vibration sensors mounted at different mounting locations (e.g., from a first vibration sensor mounted at one of mounting positions 103A to 103E in FIG. 1B and a second vibration sensor mounted at a different mounting position, from a first vibration sensor mounted to the fifth wheel and a second vibration sensor mounted to a bolster plate of the trailer, etc.). Alternatively, in some embodiments, spectrogram 702 can be provided to trained machine learning model 710 using one input channel (e.g., if single channel data is used during training), or more than two channels (e.g., if data collected concurrently from more than two vibration sensors mounted to detect vibrations of a fifth wheel are used during training). In some embodiments, spectrogram 702 can be provided to trained machine learning model 710 as a four-dimensional tensor with dimensions B×C×H×W, where B represents the number of samples processed in a batch (e.g., a number of individual audio signals that are being processed, e.g., a batch number of 8 can indicate that trained machine learning model 710 processes eight samples in parallel, which can improve processing efficiency of trained machine learning model 710; if trained machine learning model 710 is configured to process a single sample, the input can be a three-dimensional tensor C×H×W), C represents the number of input channels (e.g., corresponding to left and right audio signals of a stereo audio signal, corresponding to two copies of a mono stereo signal, etc.; if trained machine learning model 710 is configured to process mono channel data, the input can be a three-dimensional tensor B×H×W, or a two-dimensional tensor H×W if trained on single-channel single-batch data), H represents the height of the spectrogram, and W represents the width of the spectrogram.

In some embodiments, trained machine learning model 710 can include one or more convolution units 712, which can receive an input (e.g., a first convolution unit can receive spectrogram 702 as input, a subsequent convolution unit, if present, can receive an output of the previous convolution unit as input, etc.). In some embodiments, the number of convolution units 712 can be a hyperparameter that can be tuned.

In some embodiments, each convolution unit 712 can include a convolution layer 714, an activation layer 716 (e.g., a rectified linear unit (ReLU) activation layer), and a batch normalization layer 718. In some embodiments, convolution layer 714, activation layer 716, and batch normalization layer 718 can be configured to generate any suitable number of output channels (e.g., eight output channels). In some embodiments, characteristics of convolution layer 714, activation layer 716, and batch normalization layer 718 (e.g., a size of a kernel, a stride, a number of output channels, etc.) can be a hyperparameter that can be tuned.

In some embodiments, a pooling layer (e.g., an adaptive pooling layer 720) can receive, as input, outputs of a final convolution unit 712, and an output of adaptive pooling layer 720 can be provided as input to a classification layer 722.

In some embodiments, classification layer 722 can be a linear classifier (e.g., a softmax layer) configured to output a classification 724 indicative of a predicted state of the fifth wheel from which the sample of vibration data was collected. In some embodiments, classification 724 can include an identifier of the class(es) predicted to correspond to the state(s) of the fifth wheel, which can each be associated with a particular condition of the fifth wheel, and/or can include an identifier(s) of the predicted state. In some embodiments, classification layer 722 can be configured to output classification values (e.g., probabilities, logits) for any suitable number of classes. For example, classification layer 722 can be configured to output classification values for two classes, indicative of whether the fifth wheel is sufficiently greased. As another example, classification layer 722 can be configured to output classification values for three classes, indicative of whether the fifth wheel is sufficiently greased, insufficiently greased, or that there is no trailer coupled to the fifth wheel (e.g., in which case vibration data may not be useful for determining whether the fifth wheel is sufficiently greased).

In some embodiments, classification 724 can be used to generate a final prediction 740 of a current state of the fifth wheel, which can be presented to a user and/or used to alert a user to a condition of the fifth wheel. As described above in connection with 418 of FIG. 4, classification 724 can be further processed at 730 to generate final prediction 740, where further processing 730 can be configured to improve an accuracy of final prediction 740 and/or reduce volatility of final prediction 740.

As described above in connection with FIG. 4, mechanisms described herein can be implemented using a regression model (e.g., in addition to, or in lieu of, a classification model, an example of which is shown in FIG. 7A). In such embodiments, an architecture of a regression model can be similar to trained machine learning model 710, with classification layer 722 of FIG. 7A replaced by an output layer that is implemented using a linear activation function configured to output a continuous value (e.g., within a predetermined range) that represents the predicted state of the fifth wheel.

An example machine learning model with an architecture similar to trained machine learning model 710 with four convolution units was trained to classify vibration data into one of three classes, a properly greased fifth wheel (Greased), an ungreased fifth wheel (Ungreased), and a fifth wheel with no trailer (No Trailer). The training data was generated using piezoelectric microphones affixed to the bottom of a fifth wheel at positions corresponding to the position shown in FIGS. 1A and 1B using multiple layers of a double sided tape, and the fifth wheel was mounted to a tractor. The tractor was driven multiple times over a predetermined route while recording vibrations at 92 kHz. The route included multiple types of roads with multiple different speed limits, with turns, stops, and straight sections. Three datasets (labeled datasets 1, 2, and 3 below) were used in the training, each including vibration data recorded while towing a trailer carrying a load of about 35,000 pounds (loaded), the same trailer unloaded (unloaded), and with no trailer. The first and second datasets were recorded while towing a first type of trailer, and the third data set was recorded with while towing a second type of trailer with a different unloaded weight from the first type of trailer. Each trailer was towed unloaded after properly greasing the fifth wheel, unloaded after scraping off the grease from the top plate of the fifth wheel, loaded after properly greasing the fifth wheel, and loaded after scraping off the grease from the top plate of the fifth wheel.

Each of the three datasets was divided into non-overlapping two second audio files, which included audio that was downsampled from 92 kHz to 10 kHz and normalized based on the audio level within each individual sample. This resulted in a total of 158,725 two second audio files, with 20% (42,817) randomly selected and held out of the training processes as validation files, and the remaining 80% (115,908) used for training. The number of files of each class are included in TABLE 1, below. Both the training and validation data of each class, and from each dataset, included some samples recorded while idling at stop signs, driving straight, and turning on different types of roads.

TABLE 1

| | | Dataset 2 | Datasets 1 and |
|---|---|---|---|
| Class | Training | Holdout | 3 Holdout |
| Greased | 44856 | 2844 | 14280 |
| Ungreased | 44856 | 2364 | 16780 |
| No Trailer | 26196 | 1884 | 4665 |
| Total | 115908 | 7092 | 35725 |

The model was trained on 20 epochs. Before each epoch, a random time shift was applied to each audio sample, and then converted into a spectrogram with 50 millisecond time bins (e.g., 40 columns for a spectrogram representing two seconds of audio), and frequency bins with sizes based on the mel spectrum (e.g., using the melSpectrogram Matlab function), and a random row and random column of the spectrogram were zeroed out. The validation samples were also converted into a similar spectrogram for input to the trained model. After training, performance of the model was evaluated using the 20% of samples that were held out. The performance of the trained model on the validation of samples from dataset 2 are presented below in TABLE 2, and the performance of the trained model on the validation of samples from datasets 1 and 3 are presented below in TABLE 3.

TABLE 2

| | Predicted | Predicted | Predicted | Accuracy |
|---|---|---|---|---|
| Class (samples) | Greased | Ungreased | No Trailer | (%) |
| Greased (2844) | 2764 | 79 | 1 | 97.19 |
| Ungreased (2364) | 75 | 2289 | 0 | 96.83 |
| No Trailer (1884) | 0 | 0 | 1884 | 100.00 |
| | | | | 97.81 |

TABLE 3

| | Predicted | Predicted | Predicted | Accuracy |
|---|---|---|---|---|
| Class (samples) | Greased | Ungreased | No Trailer | (%) |
| Greased (14280) | 13899 | 376 | 5 | 97.33 |
| Ungreased (16780) | 700 | 16075 | 5 | 95.80 |
| No Trailer (4665) | 0 | 0 | 4665 | 100.00 |
| | | | | 96.96 |

FIG. 7B shows an example spectrogram 752 that can be used to train a machine learning model in accordance with some embodiments of the disclosed subject matter, which is normalized, includes augmentation bands along one frequency bin and two time bins, includes axis labels, and a legend.

### Further Examples Having a Variety of Features

1. A method for monitoring a state of a fifth wheel, the method comprising: providing, by one or more hardware processors, a frequency domain representation of a sample of vibration data recorded using a vibration sensor configured to be mounted to a portion of the fifth wheel to a trained machine learning model that is trained to predict a state of a fifth wheel based on vibrations of the fifth wheel; receiving, by the one or more hardware processors and from the trained machine learning model, an output indicative of a predicted state of the fifth wheel at a time that the sample of vibration data was recorded; and transmitting, by the one or more hardware processors, a signal to an external device that is indicative of a current predicted state of the fifth wheel.
2. The method of clause 1, further comprising: receiving, by the one or more hardware processors and from a vibration data source, the sample of vibration data; normalizing, by the one or more hardware processors, the sample of vibration data; and converting, by the one or more hardware processors, the sample of vibration data to the frequency domain representation.
3. The method of clause 2, wherein the vibration data source comprises the vibration sensor.
4. The method of any one of clauses 1 to 3, wherein the frequency domain representation comprises a spectrogram.
5. The method of any one of clauses 1 to 4, wherein the vibration sensor comprises a piezoelectric microphone.
6. The method of any one of clauses 1 to 5, wherein the trained machine learning model is a classification model that is trained to predict a likelihood that the fifth wheel from which the vibration data was recorded is an example of each of a plurality of classes.
7. The method of clause 6, wherein the trained machine learning model is trained to predict whether the fifth wheel is properly lubricated.
8. The method of any one of clauses 6 or 7, wherein the plurality of classes includes a properly lubricated class.
9. The method of any one of clauses 1 to 8, further comprising: receiving, by the one or more hardware processors and from the trained machine learning model, a plurality of outputs indicative of a predicted state of the fifth wheel at different times; and determining, by the one or more hardware processors, a final prediction based on the plurality of outputs; determining, by the one or more hardware processors, that a user is to be presented with an alert based on the final prediction; and transmitting the signal to the external device, thereby causing an alert to be presented to the user by the external device.
10. The method of any one of clauses 1 to 9, wherein the external device is a mobile computing device associated with the user.
11. The method of any one of clauses 1 to 9, wherein the external device is an embedded computing device of a tractor to which the fifth wheel is mounted.
12. The method of any one of clauses 1 to 9, wherein the external device is a dashboard of a tractor to which the fifth wheel is mounted.
13. The method of any one of clauses 1 to 8, wherein the external device is a remote computing device associated with a cloud computing service.
14. The method of any one of clauses 1 to 13, further comprising: receiving, by the one or more hardware processors and from the vibration sensor, a stream of audio data; recording, by the one or more hardware processors, a portion of the stream of audio data as an audio file; dividing, by the one or more hardware processors, the audio file into a plurality of vibration data samples, including the sample of vibration data; normalizing, by the one or more hardware processors, each of the plurality of the vibration data samples based on audio levels within the respective sample; converting, by the one or more hardware processors, the plurality of vibration data samples into a plurality of mel spectrograms; providing, by the one or more hardware processors, the plurality of mel spectrograms to the trained machine learning model as a batch; receiving, by the one or more hardware processors, a plurality of outputs, each corresponding to a respective vibration data sample of the plurality of vibration data samples, and each indicative of the predicted state of the fifth wheel at the time that the respective vibration data sample was recorded; and determining, by the one or more hardware processors, a final prediction based on the plurality of outputs.
15. The method of clause 14, wherein the audio file corresponds to about 16 seconds of audio data recorded at a sample rate of 96 kHz, and wherein each of the vibration data samples corresponds to about two seconds of the audio file, and is downsampled to a sample rate of 10 kHz.
16. The method of any one of clauses 1 to 5 or 9 to 15, wherein the trained machine learning model is a regression model that is trained to predict a current state of the fifth wheel from which the vibration data was recorded from a range of states.
17. The method of any one of clauses 1 to 16, wherein the state that the trained machine learning model is trained to predict is whether the fifth wheel is in a particular operating state.
18. The method of clause 17, wherein the particular is one of the following: a properly locked state; a fully unlocked state; a jammed state; or a properly coupled state.
19. The method of any one of clauses 1 to 16, wherein the state that the trained machine learning model is trained to predict is a maintenance condition of the fifth wheel.
20. The method of clause 19, wherein the maintenance condition is one of the following: whether a top plate of the fifth wheel is sufficiently lubricated; whether a locking mechanism plate of the fifth wheel is sufficiently lubricated; a condition of the lubrication on the fifth wheel; a wear condition of the top plate of the fifth wheel; a wear condition of a friction-reducing plate coupled to the fifth wheel; or a wear condition of the locking mechanism of the fifth wheel.
21. The method of any one of clauses 1 to 16, wherein the state that the trained machine learning model is trained to predict is whether a particular event occurred during a time period represented by the frequency domain representation.
22. The method of clause 21, wherein the particular event is successful coupling of the fifth wheel to a kingpin of a trailer.
23. The method of any one of clauses 1 to 22, further comprising: providing, by the one or more hardware processors, a second frequency domain representation of the sample of vibration data to a second trained machine learning model that is trained to predict a different state of the fifth wheel based on vibrations of the fifth wheel.
24. The method of any one of clauses 1 to 23, wherein the vibration sensor is mounted to an underside of the fifth wheel, the method further comprising: determining, by the one or more hardware processors and based on the output received from the trained machine learning model, that the fifth wheel is not properly greased; and transmitting, by the one or more hardware processors, the signal to an automated greasing device configured to dispense grease to a top plate of the fifth wheel, wherein the signal comprises an instruction to the automated greasing device that causes the automated greasing device to dispense a predetermined amount of grease to the fifth wheel.
25. A system comprising: one or more processors configured to: perform a method of any one of clauses 1 to 24.
26. A non-transitory computer-readable medium storing computer-executable code, comprising code for causing a computer to cause a processor to: perform a method of any of one of clauses 1 to 24.

In some embodiments, any suitable computer readable media can be used for storing instructions for performing functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that above-described steps of the process of FIGS. 5 and 6 can be executed or performed in any suitable order or sequence not limited to the order and sequence shown and described in the figures. Also, some of the above steps of the process of FIGS. 5 and 6 can be executed or performed substantially simultaneously where appropriate or in parallel to reduce latency and processing times.

This written description uses examples to disclose the invention(s), including the best mode, and also to enable any person skilled in the art to make and use the invention(s). Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention(s) is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

What is claimed is:

1. A system for monitoring a state of a fifth wheel, the system comprising:
a vibration sensor configured to be mounted to a portion of the fifth wheel; and
one or more hardware processors configured to:
provide a frequency domain representation of a sample of vibration data recorded using the vibration sensor to a trained machine learning model that is trained to predict a state of a fifth wheel based on vibrations of the fifth wheel;
receive, from the trained machine learning model, an output indicative of a predicted state of the fifth wheel at a time that the sample of vibration data was recorded; and
transmit a signal to an external device that is indicative of a current predicted state of the fifth wheel.

2. The system of claim 1, wherein the one or more hardware processors are further configured to:
receive, from a vibration data source, the sample of vibration data;
normalize the sample of vibration data; and
convert the sample of vibration data to the frequency domain representation.

3. The system of claim 2, wherein the vibration data source comprises the vibration sensor.

4. The system of claim 1, wherein the frequency domain representation comprises a spectrogram.

5. The system of claim 1, wherein the vibration sensor comprises a piezoelectric microphone.

6. The system of claim 1, wherein the one or more hardware processors are further configured to:
receive, from the trained machine learning model, a plurality of outputs indicative of a predicted state of the fifth wheel at different times; and
determine a final prediction based on the plurality of outputs;
determine that a user is to be presented with an alert based on the final prediction; and
transmit the signal to the external device, thereby causing an alert to be presented to the user by the external device.

7. The system of claim 1, wherein the external device is a dashboard of a tractor to which the fifth wheel is mounted.

8. The system of claim 1, wherein the one or more hardware processors are further configured to:
receive, from the vibration sensor, a stream of audio data;
record a portion of the stream of audio data as an audio file;
divide the audio file into a plurality of vibration data samples, including the sample of vibration data;
normalize each of the plurality of the vibration data samples based on audio levels within the respective sample;
convert the plurality of vibration data samples into a plurality of mel spectrograms;
provide the plurality of mel spectrograms to the trained machine learning model as a batch;
receive a plurality of outputs, each corresponding to a respective vibration data sample of the plurality of vibration data samples, and each indicative of the predicted state of the fifth wheel at the time that the respective vibration data sample was recorded; and
determine a final prediction based on the plurality of outputs.

9. The system of claim 8, wherein the audio file corresponds to about 16 seconds of audio data recorded at a sample rate of 96 kHz, and wherein each of the vibration data samples corresponds to about two seconds of the audio file and is downsampled to a sample rate of 10 KHz.

10. The system of claim 1, wherein the state that the trained machine learning model is trained to predict is whether the fifth wheel is in a particular operating state.

11. The system of claim 1, wherein the state that the trained machine learning model is trained to predict is a maintenance condition of the fifth wheel.

12. The system of claim 1, wherein the state that the trained machine learning model is trained to predict is whether a particular event occurred during a time period represented by the frequency domain representation.

13. The system of claim 12, wherein the particular event is successful coupling of the fifth wheel to a kingpin of a trailer.

14. The system of claim 1, wherein the one or more hardware processors are further configured to:
provide a second frequency domain representation of the sample of vibration data to a second trained machine learning model that is trained to predict a different state of the fifth wheel based on vibrations of the fifth wheel.

15. The system of claim 1, further comprising:
the fifth wheel,
wherein the vibration sensor is mounted to an underside of the fifth wheel; and
an automated greasing device configured to dispense grease to a top plate of the fifth wheel; and
wherein the one or more hardware processors configured to:
determine, based on the output received from the trained machine learning model, that the fifth wheel is not properly greased; and
transmit the signal to the automated greasing device,
wherein the signal comprises an instruction to the automated greasing device that causes the automated greasing device to dispense a predetermined amount of grease to the fifth wheel.

16. A method for monitoring a state of a fifth wheel, the method comprising:
providing, by one or more hardware processors, a frequency domain representation of a sample of vibration data recorded using a vibration sensor configured to be mounted to a portion of the fifth wheel to a trained machine learning model that is trained to predict a state of a fifth wheel based on vibrations of the fifth wheel;
receiving, by the one or more hardware processors and from the trained machine learning model, an output indicative of a predicted state of the fifth wheel at a time that the sample of vibration data was recorded; and
transmitting, by the one or more hardware processors, a signal to an external device that is indicative of a current predicted state of the fifth wheel.

17. The method of claim 16, further comprising:
receiving, from a vibration data source, the sample of vibration data;
normalizing the sample of vibration data; and
converting the sample of vibration data to the frequency domain representation.

18. The method of claim 17, wherein the vibration data source comprises the vibration sensor.

19. The method of claim 16, wherein the frequency domain representation comprises a spectrogram.

20. The method of claim 16, wherein the vibration sensor comprises a piezoelectric microphone.
